(19) United States
(12) Patent Application Publication
(10) Pub. No.: US 2014/0034465 A1
(43) Pub. Date: Feb. 6, 2014

(54) SWITCH AND METHOD FOR MANUFACTURING THE SAME, AND RELAY

(71) Applicant: OMRON Corporation, Kyoto-shi (JP)

(72) Inventors: Takahiro Masuda, Kyoto (JP); Naoki Yoshitake, Shiga (JP); Kenichi Hinuma, Kyoto (JP); Junya Yamamoto, Shiga (JP); Takashi Fujisawa, Nara (JP); Takeshi Fujiwara, Shiga (JP)

(73) Assignee: OMRON Corporation, Kyoto-shi (JP)

(21) Appl. No.: 13/961,279

(22) Filed: Aug. 7, 2013

Related U.S. Application Data
(62) Division of application No. 13/029,898, filed on Feb. 17, 2011, now abandoned.

(30) Foreign Application Priority Data
Mar. 1, 2010 (JP) 2010-043899
Mar. 10, 2010 (JP) 2010-053056

(51) Int. Cl. H01H 1/06

(52) U.S. Cl. CPC H01H 1/06
USPC 200/181; 200/275

(57) ABSTRACT

A switch and a relay include a contact with a smooth contacting surface. A side surface of a fixed contact faces a side surface of a movable contact. The fixed contact has an insulating layer and a base layer stacked on a fixed contact substrate, and a first conductive layer formed thereon through electrolytic plating. The side surface of the first conductive layer that faces the movable contact becomes the fixed contact (contacting surface). The movable contact has an insulating layer and a base layer stacked on the movable contact substrate, and a movable contact formed thereon through electrolytic plating. A side surface of a second conductive layer that faces the fixed contact becomes the movable contact (contacting surface). The fixed contact and the movable contact have surfaces that contact the side surfaces of the mold portion when growing the first and second conductive layers through electrolytic plating.

### CROSS REFERENCE TO RELATED APPLICATIONS

The present application is a divisional application of U.S. patent application Ser. No. 13/029,898 filed Feb. 17, 2011, which claims priority to Japanese Application No. 2010-043899 filed Mar. 1, 2010 and Japanese Application No. 2010-053056 filed Mar. 10, 2010. The contents of the priority applications are hereby incorporated by reference in their entirety.

### BACKGROUND OF THE INVENTION

1. Technical Field

One or more embodiments of the present invention relates to a switch and a method for manufacturing the same, and a relay. Specifically, one or more embodiments of the present invention relates to a switch that uses a metallic contact and a method for manufacturing the same, a switch in which a surface perpendicular to a moving direction of a movable contact portion is a contact and a method for manufacturing the same, and a relay that uses the structure of the switch.

2. Related Art

A MEMS (Micro Electrical-Mechanical Systems) switch in which metallic contacts are brought into contact with and separated from each other, and the surface perpendicular to the moving direction of the movable contact portion is the contact (contacting surface) is disclosed in Japanese Unexamined Patent Publication No. 2006-52627. As shown in FIG. 1A, in the switch 11, an insulating layer 13a is formed on an upper surface of a substrate 12a, a conductive layer 14a made of Al, Cu, or the like is formed thereon, and a plated layer 15a of Au or the like is grown from the upper surface to the end face of the conductive layer 14a to form a movable contact portion 17. Similarly, an insulating layer 13b is formed on an upper surface of a substrate 12b, a conductive layer 14b made of Al, Cu, or the like is formed thereon, and a plated layer 15b of Au or the like is grown from the upper surface to the end face of the conductive layer 14b to form a fixed contact portion 18. The switching operation is carried out between the movable contact portion 17 and the fixed contact portion 18 by moving the movable contact portion 17 in the direction of the arrow, and causing a movable contact 16a that is a projecting region of the plated layer 15a to come into contact with or separate from a fixed contact 16b that is a projecting region of the plated layer 15b, as shown in FIG. 1B.

An electrostatic relay in which the movable contact moves parallel to the base substrate and the movable contacts come into contact with or separate from each other is disclosed in Japanese Unexamined Patent Publication No. 9-251834. As shown in FIG. 2, in an electrostatic relay 21, a lever 24a is elastically bent by applying voltage to a movable comb teeth like electrode 22a and a fixed comb teeth like electrode 23a, and at the same time, a lever 24b is elastically bent by applying voltage to a movable comb teeth like electrode 22b and a fixed comb teeth like electrode 23b, so that a movable contact 25a formed at the distal end of the lever 24a and a movable contact 25b formed at the distal end of the lever 24b are brought into contact with each other thereby closing the movable contacts 25a, 25b. The movable contacts 25a, 25b are opened and separated by releasing the applied voltage between each comb teeth like electrode 22a and 23a and the movable comb teeth like electrode 22b and 23b. In such an electrostatic relay 21, the movable contacts 25a, 25b are formed by forming a metal film on the distal ends of the levers 24a, 24b through vapor deposition, sputtering, and the like.

The switch 11 of Japanese Unexamined Patent Publication No. 2006-526267 has a structure in which the surface of the movable contact 16a formed at the end face of the conductive layer 14a and the surface of the fixed contact 16b formed at the end face of the conductive layer 14b are brought into contact with and separated from each other, and hence the movable contact 16a and the fixed contact 16b come into contact with each other at the surface (plated surface) perpendicular to the growing direction of each plated layer 15a, 15b. However, because the surface of the plated layer is rough and includes microscopic bumps, the substantial contacting area in the case where the movable contact 16a and the fixed contact 16b are brought into contact with each other is significantly small, and the contact resistance of the contacts is large.

When voltage is applied to the conductive layers 14a, 14b for plating process, the growing speed of the plating coating is large in the projecting region (movable contact 16a, fixed contact 16b) because the electric field intensity is high at the end face of the conductive layers 14a, 14b, and hence the gap distance between the contacts is difficult to control. As the surface of the contact is rough and has irregular microscopic bumps, discharge easily occurs between the contacts when the contacts are brought close due to the variation in the gap distance. Thus, it is difficult to narrow the gap distance between the contacts in the switch 11.

A method of smoothing the surface of the contact by polishing and the like is known to resolve such drawbacks, but this increases the polishing step of the contact and becomes a cause of increase in cost of the switch and the relay.

In the electrostatic relay 21 of Japanese Unexamined Patent Publication No. 9-251834 as well, the surfaces of the movable contacts 25a, 25b formed at the end faces of the levers 24a, 24b are brought into contact with and separated from each other. Therefore, in the electrostatic relay 21 as well, the movable contacts 25a, 25b come into contact with each other at the surfaces perpendicular to the growing direction of the vapor deposition film and the like.

However, the surfaces (surfaces of contacts) perpendicular to the growing direction of such contacts are considerably rough when viewed microscopically, and have irregular microscopic bumps. The contacting area of the contacts is thus small when seen microscopically, and the contact resistance in the case where the contacts are closed is large. Furthermore, the contact resistance between the contacts tends to become unnecessarily large because the parallelism of the surfaces of the opposing contacts is difficult to obtain.

### SUMMARY OF INVENTION

One or more embodiments provide a switch in which a contacting surface of a contact is smoothly formed without performing polishing and the like and in which the contacts can be reliably brought into contact with each other so that a contact resistance between the contacts can be reduced, a method for manufacturing the switch, and a relay that uses the structure of the switch.

In accordance with one aspect of one or more embodiments of the present invention, a switch according to one or more embodiments of the present invention relates to a switch including a plurality of contacts that come into contact with or separate from each other, wherein a surface parallel to a growing direction when forming a conductive layer for forming the contacts is a contacting surface of the contacts.

In the switch of one or more embodiments of the present invention, the contacting surfaces of the contacts are surfaces parallel to the growing direction of the conductive layer, and hence the contacting surfaces of the contacts can be smoothly formed without performing polishing etc. on the contact. The contact resistance in the case where the contacts come into contact with each other thus becomes small. If the contacting surfaces of the contacts are smooth, the contacts come into contact with each other evenly, and hence the contact contacting portion is less likely to break. As a result, the open/close lifespan of the switch becomes longer, and the distance between the contacts can be narrowed.

In one aspect of the switch according to one or more embodiments of the present invention, the contacting surface of the contact is a surface in contact with a mold portion for defining a forming region of the conductive layer when growing the conductive layer. According to such an aspect, the contacting surface of the contact can be smoothly formed because the contacting surface of the contact can be formed using the surface of the mold portion.

In accordance with another aspect of one or more embodiments of the present invention, there is provided a method for manufacturing a switch including a plurality of contacts that come into contact with and separate from each other, the method including the steps of forming a mold portion of a predetermined pattern on an upper side of a substrate, growing a conductive layer in a thickness direction of the substrate in a plurality of regions excluding a region where the mold portion is formed at the upper side of the substrate, removing the mold portion and having a surface in contact with a side surface of the mold portion of the conductive layer as contacting surfaces of the contacts, and dividing the substrate into plurals in accordance with the plurality of regions formed with the conductive layer.

According to the method for manufacturing the switch of one or more embodiments of the present invention, the contacting surface of the contact can be molded by the side surface of the mold portion when forming the conductive layer, and hence the contacting surface of the contact can be smoothly formed without performing polishing and the like on the contact. The contact resistance in the case where the contacts come into contact with each other thus becomes small. As the contacting surfaces of the contacts become smooth, the contacting positions of the contacts are dispersed, and the contact contacting portion becomes less likely to break. As a result, the open/close lifespan of the switch becomes longer, and the distance between the contacts can be narrowed.

In one aspect of the method for manufacturing the switch according to one or more embodiments of the present invention, both side surfaces of the mold portion for forming the opposing contacts are formed parallel to each other. According to such an aspect, the contacting surfaces of the contacts can be made parallel to each other.

In the method for manufacturing the switch according to one or more embodiments of the present invention, the conductive layer may be grown on the upper side of the substrate through electrolytic plating or non-electrolytic plating, or may be grown on the upper side of the substrate through a deposition method such as vapor deposition and sputtering. In the case of the deposition method, the material of the conductive layer deposited on the mold portion can be removed with the mold portion in the step of removing the mold portion.

In accordance with still another aspect of one or more embodiments of the present invention, a relay according to one or more embodiments of the present invention include the switch according to one or more embodiments of the present invention, and an actuator for moving one part of the contact in a direction perpendicular to the contacting surfaces of the contacts to cause the contacts to come into contact with and separate from each other. In the relay of one or more embodiments of the present invention, the contact resistance in the case where the contacts come into contact with each other can be reduced because the contacting surfaces of the contacts can be smoothly formed. If the contacting surfaces of the contacts are smooth, the contacts come into contact with each other evenly, and hence the contact contacting portion is less likely to break. As a result, the lifespan of the relay becomes longer.

In accordance with another aspect of the switch of one or more embodiments of the present invention, the switch includes a first contact portion in which a plurality of layers including a first conductive layer is formed on an upper side of a first substrate; and a second contact portion in which a plurality of layers including a second conductive layer is formed on an upper side of a second substrate, wherein an end face parallel to the growing direction when forming the conductive layer in the first conductive layer is a contact of the first contact portion; an end face parallel to the growing direction when forming the conductive layer in the second conductive layer is a contact of the second contact portion; the contact of the contact portion projects out than an end face of a layer other than the conductive layer in the contact portion and the substrate of the contact portion in at least one of the contact portions of the first contact portion and the second contact portion, and the contact of the first contact portion and the contact of the second contact portion face each other so that the contacts come into contact with or separate from each other.

In such an aspect, the surface that becomes each contact when forming the first and second conductive layers using the MEMS technique can be smoothened and the parallelism between the contacts can be enhanced because the end face parallel in the growing direction of each first and second contact layers becomes the contact of the first contact portion and the contact of the second contact portion. Therefore, the substantial contacting area between the contacts becomes large and the contact resistance between the contacts becomes small. The welding between the contacts is less likely to occur because the contacting surfaces of the contacts become smooth, whereby the open/close lifespan of the switch becomes longer. Furthermore, because the inter-contact distance can be narrowed, the actuator can be driven at low voltage to open and close the contacts.

In such an aspect, in at least one of the contact portion of the first contact portion and the second contact portion, the contact of such a contact portion projects out than the end face of the layer other than the conductive layer in the contact portion and the substrate of the contact portion, and hence the layers other than the conductive layer or the substrates come into contact with each other before the contacts of the first contact portion and the second contact portion come into contact with each other, and the contact between the contact of the first contact portion and the contact of the second contact portion is not inhibited. Because the contacts come into contact with each other, the contact of the layers other than the conductive layer can be prevented, and the fixation of the layers other than the conductive layer can be prevented thereby extending the contact lifespan.

In another aspect of the switch according to one or more embodiments of the present invention, the first and second conductive layers are formed from any of a noble metal, an alloy, an Si material having conductivity, and a conductive oxide. According to such an aspect, the first and second conductive layers can be formed from a material having high hardness and relatively small specific resistance.

In another aspect of the switch according to one or more embodiments of the present invention, the first contact portion has a first wiring layer formed on the upper side of the first substrate and the first conductive layer formed on the upper surface of the first wiring layer, and the second contact portion has a second wiring layer formed on the upper side of the second substrate and the second conductive layer formed on the upper surface of the second wiring layer. According to such an aspect, the most suitable material can be selected for the wiring layer and the conductive layer, respectively, because the wiring layer for wiring and the conductive layer including the contact for opening and closing can be separately provided.

In another aspect of the switch according to one or more embodiments of the present invention, an end face of the wiring layer of the contact portion is an inclined surface gradually retreating in a direction of approaching the substrate of the contact portion from an end on the side in contact with the conductive layer of the contact portion in at least one of the contact portions in which the contact projects out than the end faces of the layer other than the conductive layer and the substrate. According to such an aspect, the projecting portion of the conductive layer can be supported by the wiring layer while avoiding the wiring layers from coming into contact with each other.

In another further aspect of the switch according to one or more embodiments of the present invention, the first and second wiring layers are formed from any of a noble metal, an alloy, an Si material having conductivity, or a conductive oxide. According to such an aspect, the first and second wiring layers can be formed from a material having a small specific resistance and relatively high hardness.

In accordance with yet another aspect of one or more embodiments of the present invention, another method for manufacturing a switch according to one or more embodiments of the present invention includes the steps of growing a plurality of layers including a conductive layer in a thickness direction of a substrate at an upper side of the substrate to form a plurality of layers including the conductive layer on the upper side of the substrate, and forming a mold portion of a predetermined pattern at an uppermost surface; etching the plurality of layers including the conductive layer with the mold portion as a mask to divide the plurality of layers including the conductive layer to a plurality of regions and forming a surface to become a contact from the etched surface of the contact layer; performing isotropic etching on the surface of the substrate between the divided regions of a plurality of layers including the conductive layer to form a recess at the surface of the substrate; performing anisotropic etching on the substrate between the divided regions of the plurality of layers including the conductive layer to divide the substrate into plurals in accordance with the divided region of the plurality of layers including the conductive layer; and etching a layer other than the conductive layer in at least one region of the divided regions to retreat an end face of the layer other than the conductive layer than a surface to become the contact of the conductive layer. The conductive layer is formed through a deposition method such as vapor deposition, sputtering, MBE, CVD, plating, spraying method, sol-gel method, inkjet method, and screen printing.

According to such a method for manufacturing the switch of one or more embodiments of the present invention, the surface that becomes each contact can be smoothened and the parallelism between the contacts can be enhanced because the surface that is etched when dividing the conductive layer through etching becomes the contact. Therefore, the substantial contacting area between the contacts becomes large and the contact resistance between the contacts becomes small. The welding between the contacts is less likely to occur because the contacting surfaces of the contacts become smooth, whereby the open/close lifespan of the switch becomes longer. Furthermore, because the inter-contact distance can be narrowed, the actuator can be driven at low voltage to open and close the contacts.

According to the above manufacturing method, each contact projects out than the end face of the layer other than the conductive layer and the substrate of the contact portion, and hence the layers other than the conductive layer or the substrates do not come into contact with each other before the contacts of each contact portion come into contact with each other, and the contact between the contacts is not inhibited. Because the contacts come into contact with each other, the contact of the layers other than the conductive layer can be prevented, and the fixation of the layers other than the conductive layer can be prevented thereby extending the contact lifespan.

In accordance with yet another aspect of one or more embodiments of the present invention, a method for manufacturing a switch according to one or more embodiments of the present invention includes the steps of forming a mold portion of a predetermined pattern on an upper side of a substrate and growing a plurality of layers including a conductive layer in a thickness direction of a substrate in a plurality of regions excluding a region where the mold portion is formed at the upper side of the substrate to form a plurality of layers including the conductive layer on the upper side of the substrate; removing the mold portion and forming a surface to become a contact from a surface in contact with a side surface of the mold portion of the conductive layer; performing isotropic etching on the surface of the substrate between the separated regions of the plurality of layers including the conductive layer to form a recess at the surface of the substrate; performing anisotropic etching on the substrate between the separated regions of the plurality of layers including the conductive layer to divide the substrate into plurals in accordance with the separated region of the plurality of layers including the conductive layer; and etching a layer other than the conductive layer in at least one region of the separated regions to retreat an end face of the layer other than the conductive layer than a surface to become the contact of the conductive layer. The conductive layer is formed through a film forming method such as vapor deposition, sputtering, PLD, MBE, ALD, MOCVD, thermal CVD, plating, spraying method, sol-gel method, inkjet method, and screen printing.

According to such a method for manufacturing the switch according to one or more embodiments of the present invention, the surface that becomes each contact can be smoothened and the parallelism between the contacts can be enhanced because the surface in contact with the mold portion of the conductive layer becomes the contact. Therefore, the substantial contacting area between the contacts becomes large and the contact resistance between the contacts becomes small. The welding between the contacts is less likely to occur because the contacting surfaces of the contacts become smooth, whereby the open/close lifespan of the switch becomes longer. Furthermore, because the inter-contact distance can be narrowed, the actuator can be driven at low voltage to open and close the contacts.

According to the above manufacturing method, each contact projects out than the end face of the layer other than the conductive layer and the substrate of the contact portion, and hence the layers other than the conductive layer or the substrates do not come into contact with each other before the contacts of each contact portion come into contact with each other, and the contact between the contacts is not inhibited. Because the contacts come into contact with each other, the contact of the layers other than the conductive layer can be prevented, and the fixation of the layers other than the conductive layer can be prevented thereby extending the contact lifespan.

In another aspect of the method for manufacturing the switch according to one or more embodiments of the present invention, the plurality of layers including the conductive layer has a conductive layer formed on an upper surface of a wiring layer formed on the upper side of the substrate. According to such an aspect, the most suitable material can be selected for the wiring layer and the conductive layer, respectively, because the wiring layer for wiring and the conductive layer including the contact for opening and closing can be separately provided. The wiring layer is formed through a deposition method such as vapor deposition, sputtering, MBE, CVD, plating, spraying method, sol-gel method, inkjet method, and screen printing.

In such an aspect, the step of retreating the end face of the layer other than the conductive layer than the surface to become the contact of the conductive layer includes inclining the end face of the wiring layer so as to greatly retreat towards the substrate from the conductive layer side. According to such an aspect, the projecting portion of the conductive layer can be supported by the wiring layer while avoiding the wiring layers from coming into contact with each other.

In accordance with yet another aspect of one or more embodiments of the present invention, a relay according to one or more embodiments of the present invention includes the switch according to one or more embodiments of the present invention, and an actuator for moving at least one of the first contact portion and the second contact portion in a direction perpendicular to contacting surfaces of a contact of the first contact portion and a contact of the second contact portion to cause the contacts to come into contact and separate from each other. In such a relay, the contact resistance in the case where the contacts come into contact with each other becomes small because the contacting surfaces of the contacts of the first contact portion and the second contact portion can be smoothly formed. Furthermore, discharge is less likely to occur when the contacts are brought close and the welding between the contacts is also less likely to occur as the contacting surfaces of the contacts are smooth. As a result, the lifespan of the relay becomes longer. Because the contact projects out than the end faces of other layers and the end face of the substrate, the layers other than the conductive layer and the substrates do come into contact with each other before the contacts come into contact with each other, whereby the contact between the contact of the first contact portion and the contact of the second contact portion is not inhibited.

One or more embodiments of the present invention have characteristics in which the constituent elements described above are appropriately combined, where one or more embodiments of the present invention include a great number of variations obtained by combining the constituent elements.

### BRIEF DESCRIPTION OF THE DRAWINGS

FIGS. 1A and 1B are cross-sectional views showing a MEMS switch disclosed in Japanese Unexamined Patent Publication No. 2006-526267;

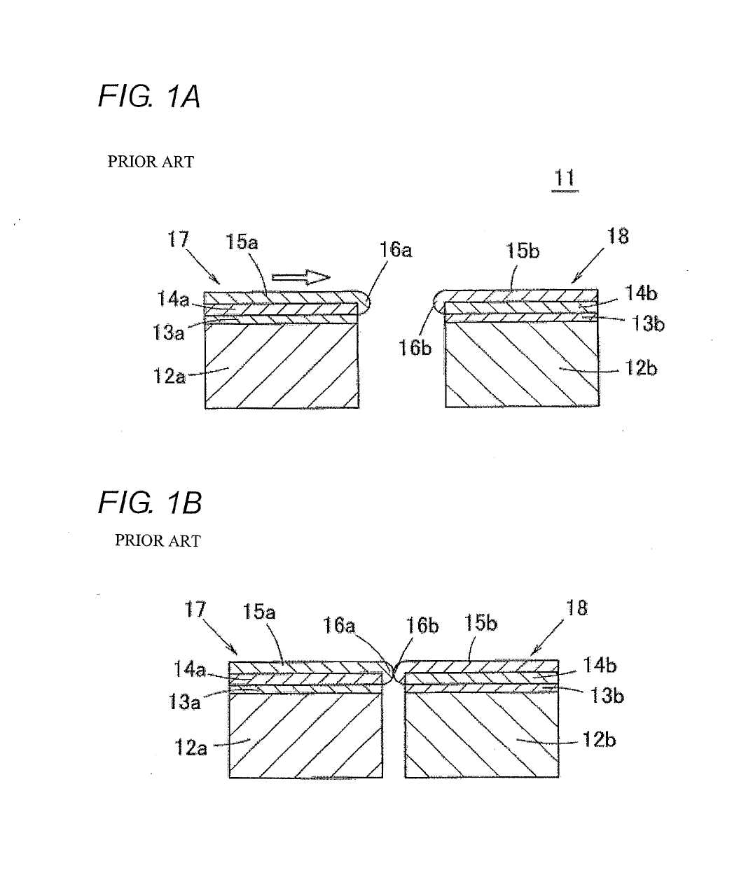

FIG. 2 is a perspective view of an electrostatic relay disclosed in Japanese Unexamined Patent Publication No. 9-251834;

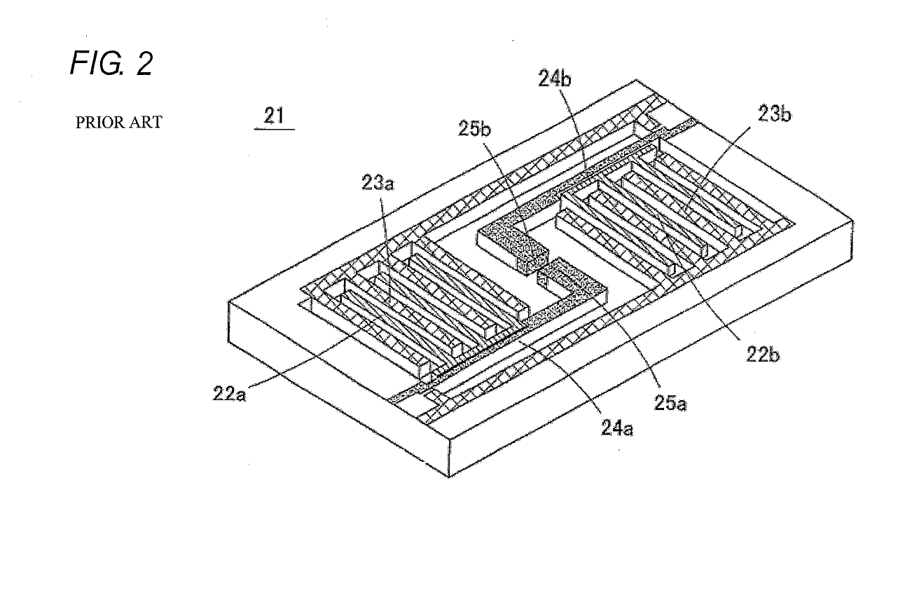

FIG. 3 is a cross-sectional view showing a structure of a switch according to a first embodiment of the present invention;

FIGS. 4A to 4D are schematic cross-sectional views describing a first method for manufacturing the switch of the first embodiment;

FIGS. 5A to 5D are schematic cross-sectional views describing a second method for manufacturing the switch of the first embodiment;

FIG. 6 is a plan view showing an electrostatic relay according to a second embodiment of the present invention;

FIG. 7 is a perspective view showing an area A of FIG. 6 in an enlarged manner;

FIG. 8 is a schematic cross-sectional view taken along line B-B of FIG. 6.

FIGS. 9A and 9B are cross-sectional views showing a structure of a switch according to a third embodiment of the present invention;

FIGS. 10A to 10D are schematic cross-sectional views describing a third method for manufacturing the switch of the third embodiment;

FIGS. 11A to 11D are schematic cross-sectional views showing the steps following FIG. 10;

FIGS. 12A to 12D are schematic cross-sectional views describing a fourth method for manufacturing the switch of the third embodiment;

FIGS. 13A to 13D are schematic cross-sectional views showing the steps following FIG. 12D;

FIGS. 14A to 14D are schematic cross-sectional views describing a fifth method for manufacturing the switch of the third embodiment;

FIG. 15 is a cross-sectional view showing a structure of a switch according to a fourth embodiment of the present invention;

FIGS. 16A to 16D are schematic cross-sectional views describing a sixth method for manufacturing the switch of the fourth embodiment;

FIGS. 17A to 17C are schematic cross-sectional views showing the steps following FIG. 16D;

FIGS. 18A to 18D are schematic cross-sectional views describing a seventh method for manufacturing the switch of the fourth embodiment;

FIGS. 19A to 19C are schematic cross-sectional views showing the steps following FIG. 18D;

FIG. 20 is a plan view showing an electrostatic relay according to a fifth embodiment of the present invention;

FIG. 21 is a perspective view showing an area A of FIG. 20 in an enlarged manner; and

FIG. 22 is a schematic cross-sectional view taken along line B-B of FIG. 20.

### DETAILED DESCRIPTION

Embodiments of the present invention will be described with reference to the accompanying drawings. The present invention is not limited to the following embodiments, and various design changes can be made within a scope not departing from the gist of the invention. In embodiments of the invention, numerous specific details are set forth in order to provide a more thorough understanding of the invention. However, it will be apparent to one with ordinary skill in the art that the invention may be practiced without these specific details. In other instances, well-known features have not been described in detail to avoid obscuring the invention.

### First Embodiment

(Structure)

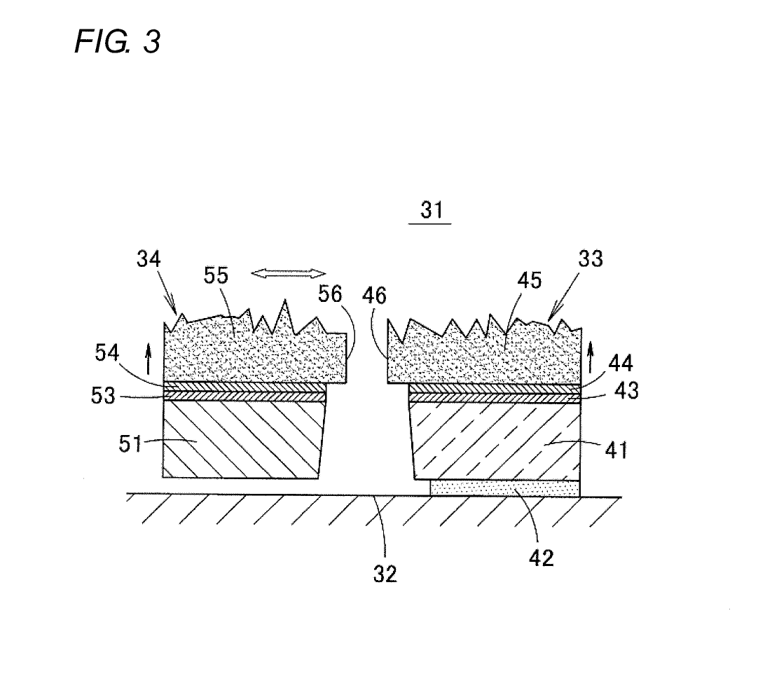

FIG. 3 is a cross-sectional view showing a structure of a switch according to a first embodiment of the present invention. The switch 31 includes a fixed contact portion 33 and a movable contact portion 34. The fixed contact portion 33 is fixed to an upper surface of a base substrate 32 through an insulating film 42, and the movable contact portion 34 moves in a direction (direction indicated with outlined arrow) parallel to the upper surface of the base substrate 32 by a drive mechanism or an actuator. For instance, the switch of one or more embodiments of the present invention can be used in the MEMS switch having the structure disclosed in Japanese Unexamined Patent Publication No. 2006-526267.

The fixed contact portion 33 is obtained by forming an insulating layer 43 and a base layer 44 on the upper surface of a fixed contact substrate 41, and forming a conductive layer 45 thereon. The conductive layer is also referred to as a contact layer, but is standardized as a conductive layer in the present specification. The movable contact portion 34 is obtained by forming an insulating layer 53 and a base layer 54 on the upper surface of a movable contact substrate 51, and forming a conductive layer 55 thereon. The conductive layers 45, 55 are formed by growing a conductive material in the thickness direction (direction of arrow in FIG. 3) through electrolytic plating and non-electrolytic plating, vapor deposition, sputtering and the like, where the respective opposing side surfaces become a fixed contact 46 (electrical contacting surface) and a movable contact 56 (electrical contacting surface). The material of the conductive layers 45, 55 may be Pt, Au, Pd, Ir, Ru, Rh, Re, Ta, Pt alloy, Au alloy and the like. The fixed contact 46 and the movable contact 56 are smoothly formed parallel to each other. Therefore, when the movable contact portion 34 is moved parallel so that the fixed contact 46 comes into contact with the movable contact 56 to close the contacts 46, 56, the contacts 46, 56 come into contact with each other substantially over the entire surface.

The opposing portions of the conductive layer 45 and the conductive layer 55 respectively project out from the end face of the fixed contact substrate 41 and the movable contact substrate 51, and the opposing surfaces of the fixed contact substrate 41 and the movable contact substrate 51 are both inclined to retreat towards the lower surface side. Therefore, when moving the movable contact portion 34 to bring the movable contact 56 in contact with the fixed contact 46, the fixed contact substrate 41 and the movable contact substrate 51 do not contact to thereby inhibit the contact of the movable contact 56 and the fixed contact 46.

(First Manufacturing Method)

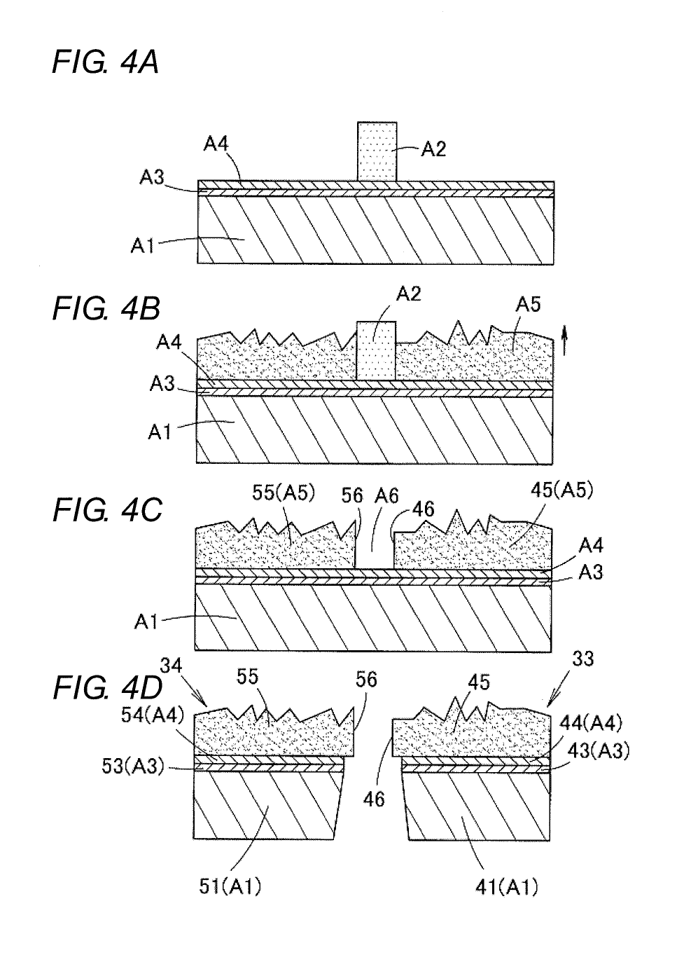

The switch 31 is formed using the MEMS (Micro Electrical-Mechanical Systems) technique. The manufacturing method shown in FIG. 4A to FIG. 4D forms the conductive layers 45, 55 through electrolytic plating. In FIG. 4A, an insulating layer A3 such as SiO2 and a plated base layer A4 are formed on a substrate A1l made of Si, and a mold portion A2 is formed on the plated base layer A4. The plated base layer A4 becomes a plated electrode and has a two-layer structure including a lower layer Cr/an upper layer Au, and has the function of enhancing the adhesiveness (stripping strength) of the insulating layer A3 and the conductive layer A5. The mold portion A2 uses a material that has resistance to plating solution and that is selectively removed through etching without corroding the conductive layer A5 in the subsequent mold portion removing step. For instance, the mold portion A2 may be formed by exposing a photoresist applied on the upper surface of the plated base layer A4 through an exposure mask, and patterning by etching. Alternatively, the mold portion A2 may be obtained by forming an oxide film (SiO2), a nitride film (SiN), an alumina film (Al2O3), and a metal film of a type different from the conductive layers 45 and 55 on the upper surface of the plated base layer A4, and then patterning such films using the photolithography technique. The mold portion A2 is thus formed in the region other than the region to form the conductive layers 45, 55, and both side surfaces of the mold portion A2 patterned between the regions to form the conductive layers 45, 55 become parallel to each other and also smooth. Although not shown in FIG. 4A, the entire lower surface of the substrate A1 is fixed to the upper surface of the base substrate 32 including an Si substrate, a glass substrate, or the like through the insulating film 42 such as the SiO2.

The substrate A1 is then immersed in the plating bath and electrolytic plating is carried out with the plated base layer A4 as the plating electrode, so that the plating metal particles such as Pt gradually precipitate on the surface of the plated base layer A4 and the conductive layer A5 grows in the thickness direction of the substrate A1, as shown in FIG. 4B. The plating metal particles do not precipitate at the region covered by the mold portion A2. The non-electrolytic plating (chemical plating) may be performed instead of the electrolytic plating.

After cleaning the substrate A1 taken out from the plating bath with water, the mold portion A2 is removed by etching, so that a cavity A6 is formed at the area where the mold portion A2 existed between the regions to form the conductive layers 45, 55, as shown in FIG. 4C. One conductive layer A5 separated by the cavity A6 becomes the conductive layer 55, and the side surface facing the cavity A6 becomes the movable contact 56. The other conductive layer A5 separated by the cavity A6 becomes the conductive layer 45, and the side surface facing the cavity A6 becomes the fixed contact 46.

Then, as shown in FIG. 4D, the etchant is infiltrated from the cavity A6 to sequentially divide the plated base layer A4 and the insulating layer A3 into two. Furthermore, the substrate A1 is etched from the lower surface side or etched from the cavity A6 side to be divided into two blocks, where one block becomes the base layer 54, the insulating layer 53, and the movable contact substrate 51 and the other block becomes the base layer 44, the insulating layer 43, and the fixed contact substrate 41.

One of the blocks thus becomes the fixed contact portion 33 where the fixed contact substrate 41, the insulating layer 43, the base layer 44, and the conductive layer 45 are stacked. The fixed contact portion 33 is fixed to the upper surface of the base substrate 32 through the insulating film 42. The other block becomes the movable contact portion 34 where the movable contact substrate 51, the insulating layer 53, the base layer 54, and the conductive layer 55 are stacked. The movable contact portion 34 is separated from the base substrate 32 by lastly removing the insulating film at the lower surface through etching, whereby the switch 31 (MEMS switch) is formed.

(Second Manufacturing Method)

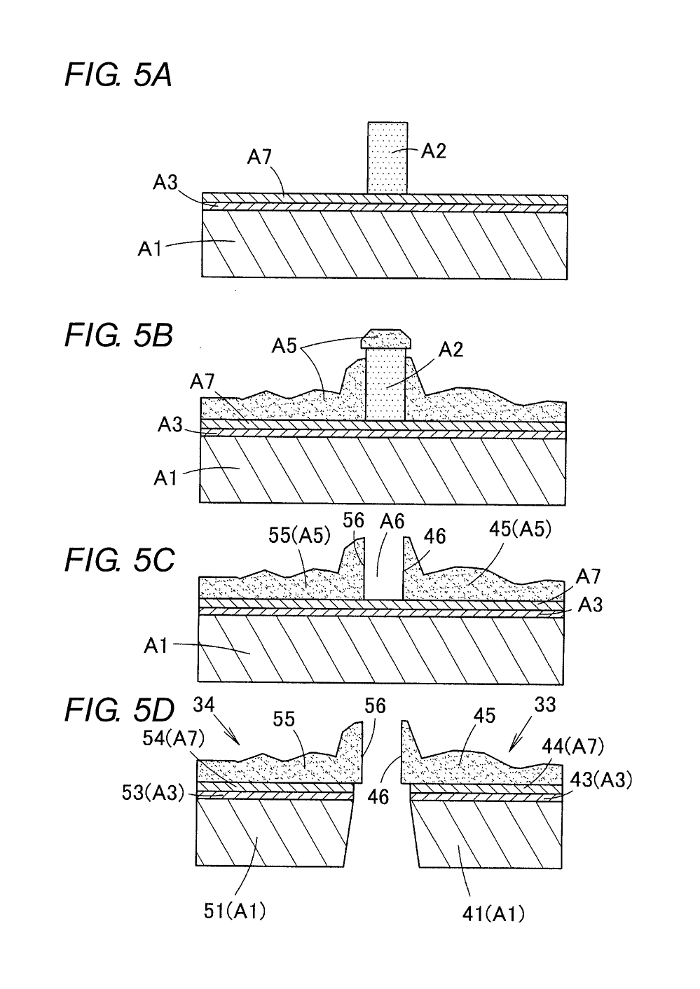

The switch 31 can be formed through steps shown in FIGS. 5A to 5D. This manufacturing method forms the conductive layers 45, 55 by vapor deposition, sputtering, and the like. FIG. 5A is a step corresponding to FIG. 4A, but an adhesion layer A7 (e.g., two-layer structure of lower layer Cr/upper layer Au) for enhancing the adhesion strength (stripping strength) of the insulating layer A3 and the conductive layer A5 formed in place of the plated base layer A4 on the insulating layer A3. In the step of FIG. 5B, the metal material such as Pt is deposited on the adhesion layer A7 through vapor deposition, sputtering, and the like. The conductive layer A5 is also deposited on the mold portion A2 as shown in FIG. 5B according to the deposition method such as vapor deposition, sputtering, and the like, but the conductive layer A5 on the mold portion A2 is simultaneously removed when removing the mold portion A2 through etching if the mold portion A2 has a sufficient height (lift off method).

The cavity A6 is formed after the mold portion A2 is removed as shown in FIG. 5C, and the conductive layer A5 is separated into the conductive layer 55 and the conductive layer 45, which is the same as the step of FIG. 4C. Furthermore, as shown in FIG. 5D, the etchant is infiltrated from the cavity A6 to sequentially divide the adhesion layer A7 and the insulating layer A3 into two, and furthermore, the substrate A1 is divided into two blocks, where one block becomes the base layer 54, the insulating layer, 53 and the movable contact substrate 51 and the other block becomes the base layer 44, the insulating layer 43, and the fixed contact substrate 41, which is the same as the step of FIG. 4D.

(Effects)

In the switch 31 of one or more embodiments of the present invention, the contacting surface can be smoothly molded with the side surface of the mold portion without performing polishing and the like because the contacting surface of the fixed contact 46 and the contacting surface of the movable contact 56 are parallel to the growing direction of the conductive layer A5. The parallelism of the contacting surfaces of the contacts 46, 56 can be enhanced. The contact resistance in the case where the contacts 46, 56 are in contact with each other thus becomes small.

Because the accuracy of the gap distance between the contacts 46, 56 can be enhanced while reducing variation, the gap distance between the contacts can be narrowed and the movement distance of the movable contact 56 by the actuator can be reduced. Furthermore, the contacting positions of the contacts are dispersed because the surfaces of the fixed contact 46 and the movable contact 56 are smooth, and hence the contact contacting portion is less likely to break and the open/close lifespan of the switch 31 becomes longer.

### Second Embodiment

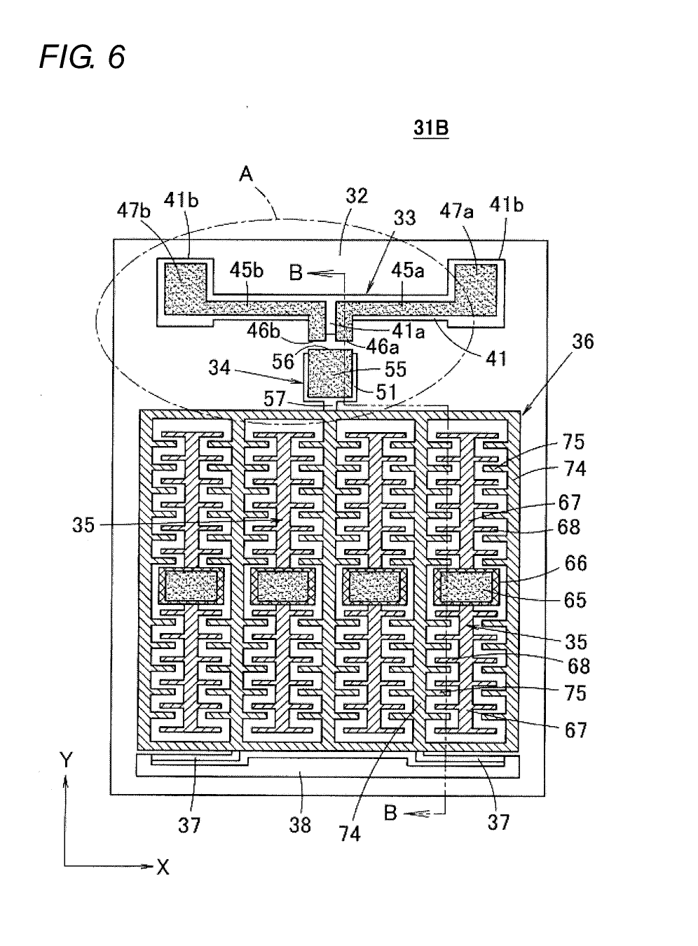

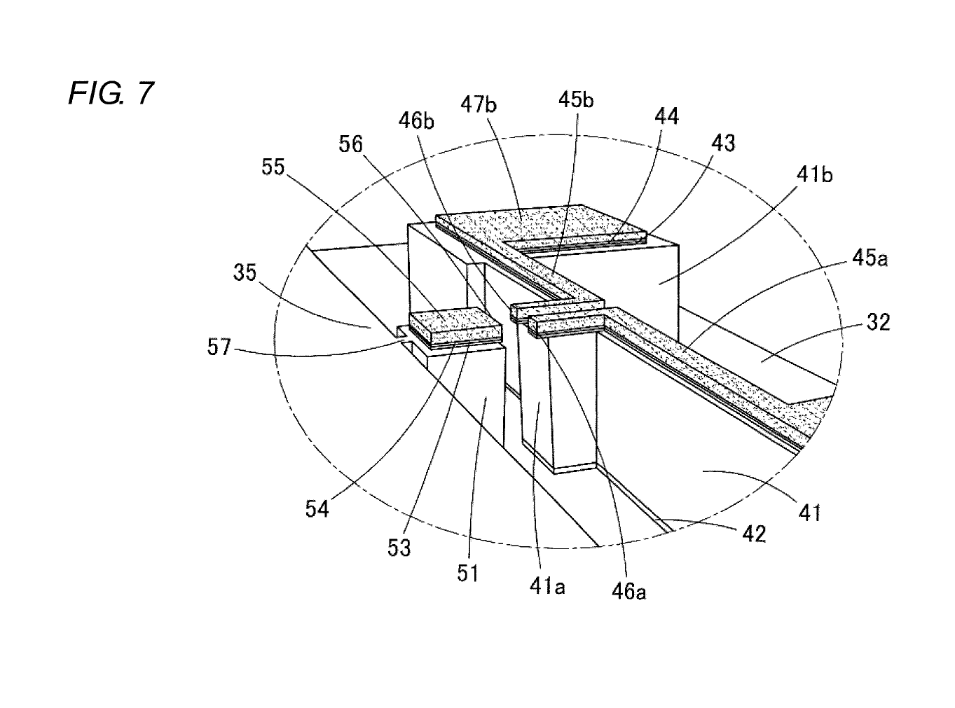

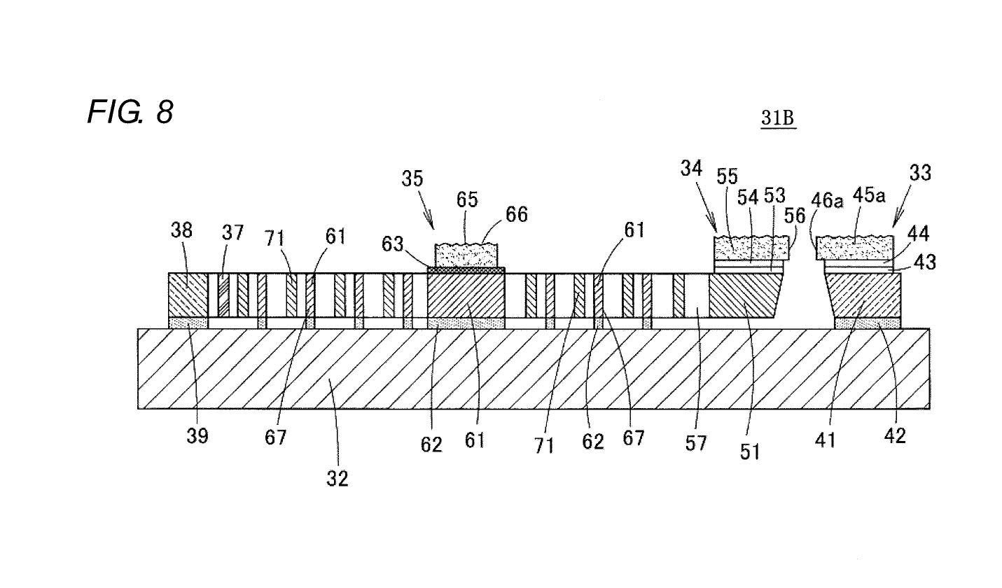

A structure of an electrostatic relay 31B for high frequency according to a second embodiment of the present invention will now be described. FIG. 6 is a plan view showing a structure of the electrostatic relay 31B. FIG. 7 is a perspective view showing an area A of FIG. 6 in an enlarged manner. FIG. 8 is a schematic cross-sectional view taken along line B-B of FIG. 6.

The electrostatic relay 31B has the fixed contact portion 33, the movable contact portion 34, a fixed electrode portion 35, a movable electrode portion 36 for supporting the movable contact portion 34, an elastic spring 37, and a supporting portion 38 for supporting the elastic spring 37 arranged on the upper surface of the base substrate 32 including the Si substrate, the glass substrate, or the like.

As shown in FIG. 8, the fixed contact portion 33 has the lower surface of the fixed contact substrate 41 made of Si fixed to the upper surface of the base substrate 32 by the insulating film 42 (SiO2). The insulating layer 43 including an oxide film (SiO2), a nitride film (SiN), or the like is formed on the upper surface of the fixed contact substrate 41, the base layer 44 including the lower layer Cr/upper layer Au is formed on the upper surface thereof, and the conductive layers 45a, 45b of Pt and the like are formed on the base layer 44.

As shown in FIG. 6 and FIG. 7, the fixed contact substrate 41 extends in the width direction (X direction) at the end on the upper surface of the base substrate 32, where a bulging-out portion 41a projecting out towards the movable contact portion 34 side is formed at the central part and pad supporting portions 41b, 41b are formed at both ends. The conductive layers 45a, 45b are wired along the upper surface of the fixed contact substrate 41, where one of the ends of the conductive layers 45a, 45b are arranged parallel to each other on the upper surface of the bulging-out portion 41a, and the distal end faces of the portion projecting out from the end face of the bulging-out portion 41a are positioned within the same plane to become the fixed contacts 46a, 46b (electrical contacting surface), respectively. The other ends of the conductive layers 45a, 45b have metal pad portions 47a, 47b formed on the upper surface of the pad supporting portions 41b, 41b.

The movable contact portion 34 is arranged at a position facing the bulging-out portion 41a. As shown in FIG. 8, the movable contact portion 34 has the insulating layer 53 including the oxide film (SiO2), the nitride film (SiN), or the like formed on the upper surface of the movable contact substrate 51 made of Si, the base layer 54 including the lower layer Cr/upper layer Au formed on the upper surface thereof, and the conductive layer 55 of Pt and the like formed on the base layer 54. The end face of the conductive layer 55 facing the conductive layers 45a, 45b projects out from the front surface of the movable contact substrate 51 and is formed parallel to the fixed contact 46a, 46b, whereby the relevant end face becomes the movable contact 56 (electrical contacting surface). The movable contact 56 has a width substantially equal to the distance from the edge on the outer side of the fixed contact 46a to the edge on the outer side of the fixed contact 46b.

The movable contact substrate 51 is supported in a cantilever manner by a supporting beam 57 projecting out from the movable electrode portion 36. The lower surfaces of the movable contact substrate 51 and the supporting beam 57 are floating from the upper surface of the base substrate 32, and can move parallel to the length direction (Y direction) of the base substrate 32 with the movable electrode portion 36.

In the electrostatic relay 31B, a main circuit (not shown) is connected to the metal pad portions 47a, 47b of the fixed contact portion 33, where the main circuit can be closed by bringing the movable contact 56 in contact with the fixed contacts 46a, 46b, and the main circuit can be opened by separating the movable contact 56 from the fixed contacts 46a, 46b. The opposing surfaces of the bulging-out portion 41a and the movable contact substrate 51 are inclined to retreat towards the lower side, and the fixed contacts 46a, 46b are projected out than the bulging-out portion 41a and the movable contact 56 is also projected out from the movable contact substrate 51, and hence the bulging-out portion 41a and the movable contact substrate 51 do not come into contact when closing the contacts thereby preventing the movable contact 56 and the fixed contacts 46a, 46b from causing contact failure.

The actuator for moving the movable contact portion 34 is configured by the fixed electrode portion 35, the movable electrode portion 36, the elastic spring 37, and the supporting portion 38.

As shown in FIG. 6, a plurality of fixed electrode portions 35 is arranged in parallel to each other on the upper surface of the base substrate 32. In plan view, the fixed electrode portion 35 has a branch-like electrode part 67 of a branch-shape extending in the Y direction from both surfaces of a rectangular pad portion 66. The branch-like electrode part 67 has a branch portion 68 projecting out so as to be symmetrical to each other, which branch portion 68 is lined at a constant pitch in the Y-direction.

As shown in FIG. 8, the lower surface of the fixed electrode substrate 61 is fixed to the upper surface of the base substrate 32 by the insulating film 62 in the fixed electrode portion 35. In the pad portion 66, the fixed electrode 63 is formed by Cu, Al, and the like on the upper surface of the fixed electrode substrate 61, and an electrode pad layer 65 is arranged above the fixed electrode 63.

As shown in FIG. 6, the movable electrode portion 36 is formed to surround each fixed electrode portion 35. The movable electrode portion 36 includes a comb teeth like electrode portion 74 formed so as to sandwich each fixed electrode portion 35 from both sides (branch-shape by a pair of comb teeth like electrode portions 74 between the fixed electrode portions 35). The comb teeth like electrode portion 74 is symmetric with each fixed electrode portion 35 as the center, where a comb teeth part 75 extends from each comb teeth like electrode portion 74 to a clearance between the branch portions 68. Furthermore, each comb teeth part 75 has the distance with the branch portion 68 positioned on the side close to the movable contact portion 34 adjacent to the comb teeth part 75 shorter than the distance with the branch portion 68 positioned on the side distant from the movable contact portion 34 adjacent to the comb teeth part 75.

The movable electrode portion 36 includes a movable electrode substrate 71 of Si, where the lower surface of the movable electrode substrate 71 is floating from the upper surface of the base substrate 32. The supporting beam 57 is arranged in a projecting manner at the center of the end face on the movable contact side of the movable electrode portion 36, and the movable contact portion 34 is held at the distal end of the supporting beam 57.

The supporting portion 38 is made of Si, and extends long in the X direction at the other end of the base substrate 32. The lower surface of the supporting portion 38 is fixed to the upper surface of the base substrate 32 by the insulating film 39. Both ends of the supporting portion 38 and the movable electrode portion 36 (movable electrode substrate 71) are connected by a pair of elastic springs 37 formed symmetrically by Si, where the movable electrode portion 36 is horizontally supported by the supporting portion 38 by way of the elastic spring 37. The movable electrode portion 36 is movable in the Y direction by elastically deforming the elastic spring 37.

In the electrostatic relay 31B having the above structure, a DC voltage source is connected between the fixed electrode portion 35 and the movable electrode portion 36, and the DC voltage is turned ON and OFF by the control circuit and the like. In the fixed electrode portion 35, one terminal of the DC voltage source is connected to the electrode pad layer 65. The other terminal of the DC voltage source is connected to the supporting portion 38. The supporting portion 38 and the elastic spring 37 have conductivity, and the supporting portion 38, the elastic spring 37, and the movable electrode substrate 71 are electrically conducted, and hence the voltage applied to the supporting portion 38 will be applied to the movable electrode substrate 71.

When the DC voltage is applied between the fixed electrode portion 35 and the movable electrode portion 36 by the DC voltage source, an electrostatic attractive force is generated between the branch portion 68 of the branch like electrode part 67 and the comb teeth part 75 of the comb teeth like electrode portion 74. However, the electrostatic attractive force in the X direction acting on the movable electrode portion 36 becomes balanced because the structure of the fixed electrode portion 35 and the movable electrode portion 36 is formed symmetric with respect to the center line of each fixed electrode portion 35, whereby the movable electrode portion 36 does not move in the X direction. Because the distance with the branch portion 68 positioned on the side close to the movable contact portion 34 adjacent to the comb teeth part 75 is shorter than the distance with the branch portion 68 positioned on the side distant from the movable contact portion 34 adjacent to the comb teeth part 75, each comb teeth part 75 is attracted to the movable contact portion side, and the movable electrode portion 36 moves in the Y direction while bending the elastic spring 37. As a result, the movable contact portion 34 moves to the fixed contact portion 33 side, and the movable contact 56 comes into contact with the fixed contacts 46a, 46b thereby electrically closing the fixed contact 46a and the fixed contact 46b (main circuit).

When the DC voltage applied between the fixed electrode portion 35 and the movable electrode portion 36 is released, the electrostatic attractive force between the branch portion 68 and the comb teeth part 75 disappears, whereby the movable electrode portion 36 moves backward in the Y direction by the elastic returning force of the elastic spring 37 thereby separating the movable contact 56 from the fixed contacts 46a, 46b and opening the fixed contact 46a and the fixed contact 46b (main circuit).

Such an electrostatic relay 31B is formed through the following steps. First, the Si substrate (another Si wafer having conductivity) is joined to the upper surface of the base substrate 32 (Si wafer, SOI wafer, etc.) having the entire surface covered with the insulating film, and the metal material is vapor deposited on the upper surface of the Si substrate to form the electrode film. The electrode film is then patterned by the photolithography technique, and the fixed electrode 63 is formed on the upper surface of the fixed electrode substrate 61 at the pad portion 66 by the electrode film.

Thereafter, the insulating layer, the base layer, and the conductive layer are stacked on the upper surface of the Si substrate from above the electrode film. The conductive layer is then patterned to form the conductive layers 45a, 45b of the fixed contact portion 33, the conductive layer 55 of the movable contact portion 34, and the electrode pad layer 65 of the fixed electrode portion 35. The conductive layers 45a, 45b and the conductive layer 55 are removed through etching leaving the base layer and the insulating layer at the lower surface, where the base layers 44, 54 are formed by the remaining base layer and the insulating layers 43, 53 are formed by the remaining insulating layer.

The fixed electrode 63, the conductive layers 45a, 45b, and the conductive layer 55 may be simultaneously formed through procedures different from the above.

Thereafter, a photoresist is applied on the conductive layer 45a, the conductive layer 55, the fixed electrode 63, and the like to form a resist mask, the Si substrate is etched through the resist mask, and the fixed contact substrate 41 of the fixed contact portion 33, the movable contact substrate 51 of the movable contact portion 34, the fixed electrode substrate 61 of the fixed electrode portion 35, the movable electrode substrate 71 of the movable electrode portion 36, the elastic spring 37, and the supporting portion 38 are formed from the Si substrate remaining in each region.

Lastly, the insulating film of the region exposed from the Si substrate and the insulating film at the lower surfaces of the movable contact portion 34 and the movable electrode portion 36 are removed through etching, and then cut to individual electrostatic relay 31B.

In the manufacturing steps of the electrostatic relay 31B, the movable contact portion 34 and the fixed electrode portion 35 are formed through steps similar to the steps shown in FIG. 4 or FIGS. 5A to 5D, and hence the fixed contacts 46a, 46b of the fixed contact portion 33 and the movable contact 56 of the movable contact portion 34 becomes side surfaces parallel to the growing direction of the conductive layer, and a contact with satisfactory smoothness and parallelism can be obtained without performing polishing and the like. Effects similar to the switch 31 of the first embodiment thus can be obtained in the electrostatic relay 31B as well.

### Third Embodiment

(Structure)

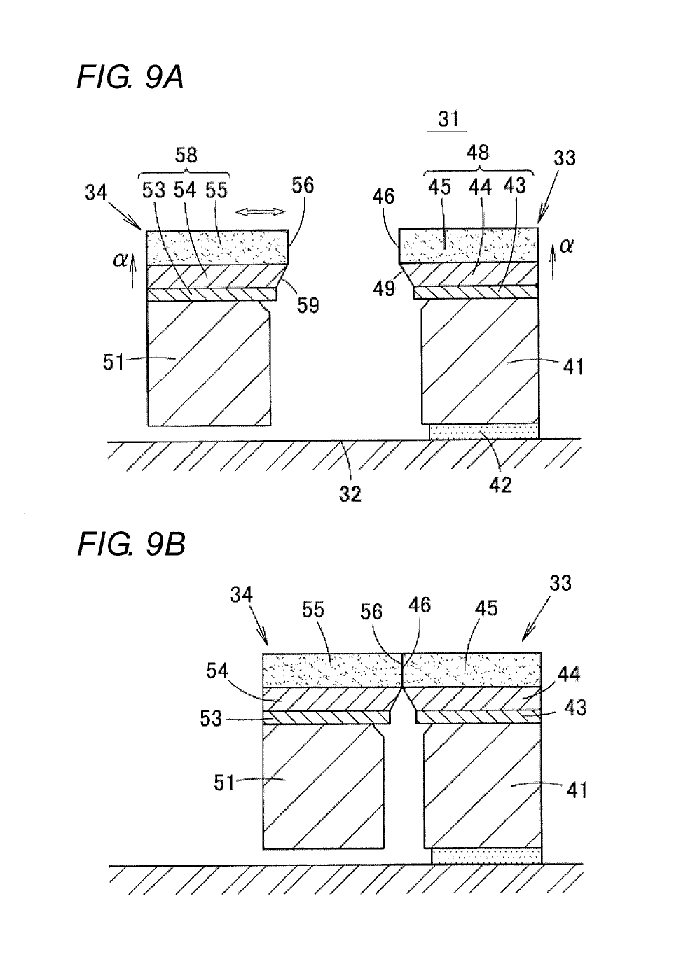

FIG. 9A is a cross-sectional view showing a structure of the switch according to the third embodiment of the present invention. The switch 31 includes a fixed contact portion 33 and a movable contact portion 34. The fixed contact portion 33 has the lower surface fixed to the upper surface of the base substrate 32 through the insulating film 42, and the movable contact portion 34 is floated from the upper surface of the base substrate 32 and can move in a direction (direction indicated with outlined arrow) parallel to the upper surface of the base substrate 32 by an actuator. For instance, the switch of one or more embodiments of the present invention can be used in the MEMS switch having the structure disclosed in Japanese Unexamined Patent Publication No. 2006-526267.

The fixed contact portion 33 includes a wiring pattern 48 formed on the upper surface of the fixed contact substrate 41. The wiring pattern 48 includes the adhesion layer 43 positioned on the upper surface of the fixed contact substrate 41, and the wiring layer 44 and the conductive layer 45 stacked thereon. The movable contact portion 34 includes a wiring pattern 58 formed on the upper surface of the movable contact substrate 51. The wiring pattern 58 includes the adhesion layer 53 positioned on the upper surface of the movable contact substrate 51, and the wiring layer 54 and the conductive layer 55 stacked thereon.

The adhesion layer 43 is a layer for enhancing the adhesion strength (stripping strength) of the wiring layer 44 and the fixed contact substrate 41. The adhesion layer 53 is a layer for enhancing the adhesion strength (stripping strength) of the wiring layer 54 and the fixed contact substrate 41. The adhesion layers 43, 53 have a two-layer structure including a lower layer Cr/an upper layer Au, and are formed through methods such as CVD, vapor deposition, sputtering, electrolytic plating, non-electrolytic plating, and the like. The wiring layers 44, 54 are preferably made of material having small specific resistance and high hardness, and is configured by noble metal or alloy such as Pt, Rh, Pd, and Au, Si material such as polysilicon (Poly-Si), doped silicon (doped Si) and doped polysilicon doped with impurities, and conductive oxide such as AgO and SrRuO3. The conductive layers 45, 55 are also preferably made of material having small specific resistance and high hardness, and is configured by noble metal such as Pt, Rh, Pd, and Au, Si material such as polysilicon, doped silicon and doped polysilicon, and conductive oxide such as AgO and SrRuO3. The wiring layers 44, 54 and the conductive layers 45, 55 are formed through the deposition method such as vapor deposition, sputtering, MBE, CVD, plating, spraying method, sol-gel method, inkjet method, screen printing, and the like.

The conductive layers 45, 55 are layers for forming the fixed contact and the movable contact that come into contact with and separate from each other, where the sticking (fixing) is less likely to occur when the contacts come into contact with each other and the lifespan of the switch 31 is longer the higher the hardness of the material, and hence the material of high hardness is selected for the material of the conductive layers 45, 55. The wiring layers 44, 54, on the other hand, are layers for transmitting signals and do not directly come into contact with each other, where the effect of alleviating the impact when the contacts come into contact can be expected even if the layers are soft, and hence the material of low resistance is selected rather than the material of high hardness for the material of the wiring layers 44, 54. Therefore, the material of low resistance and high hardness is used for the wiring layers 44, 54 and the conductive layers 45, 55 as well, but the wiring layers 44, 54 are typically formed from a material of smaller specific resistance than the conductive layers 45, 55, and the conductive layers 45, 55 are formed from a material of higher hardness than the wiring layers 44, 54.

The adhesion layers 43, 53, the wiring layers 44, 54, and the conductive layers 45, 55 are formed by growing the respective material in the thickness direction (direction α of the arrow in FIG. 9). The opposing end face of the conductive layer 45 of the respective opposing end faces of the conductive layer 45 and the conductive layer 55 becomes the fixed contact 46 (electrical contacting surface), and the opposing end face of the conductive layer 55 becomes the movable contact 56 (electrical contacting surface). Therefore, the fixed contact 46 is an end face parallel to the growing direction a of the conductive layer 45, or a surface perpendicular to the surface of the conductive layer 45. The movable contact 56 is also an end face parallel to the growing direction a of the conductive layer 55, or a surface perpendicular to the surface of the conductive layer 55. The fixed contact 46 and the movable contact 56 are parallel to each other and are both smoothly formed. However, the fixed contact 46 and the movable contact 56 may not necessarily be a plane and may be a curved surface.

The fixed contact 46 projects out in the horizontal direction than the end face of the fixed contact substrate 41 and the end face of the adhesion layer 43 at the surface facing the movable contact portion 34. The end at the upper surface of the wiring layer 44 is aligned with the fixed contact 46 or is retreated than the fixed contact 46, and the end face 49 of the wiring layer 44 is retreated so as to move away from the movable contact portion 34 as the end face 49 approaches the fixed contact substrate 41 side. Similarly, the movable contact 56 projects out in the horizontal direction than the end face of the movable contact substrate 51 and the end face of the adhesion layer 53 at the surface facing the fixed contact portion 33. The end at the upper surface of the wiring layer 54 is aligned with the movable contact 56 or is retreated than the movable contact 56, and the end face 59 of the wiring layer 54 is retreated so as to move away from the fixed contact portion 33 as the end face 59 approaches the movable contact substrate 51 side.

In the fixed contact portion 33 and the movable contact portion 34, an insulating layer may be formed between the adhesion layer 43, 53 and each substrate 41, 51.

In the switch 31, when the movable contact portion 34 is moved in a direction parallel to the upper surface of the base substrate 32 by an actuator, and the like, the fixed contact 46 of the fixed contact portion 33 and the movable contact 56 of the movable contact portion 34 come into contact with each other, and the fixed contact 46 and the movable contact 56 are electrically closed, as shown in FIG. 9B. Furthermore, because the conductive layers 45, 55 project out in the horizontal direction than the end faces of the wiring layers 44, 54 and the adhesion layers 43, 53 and the end faces of each substrates 41, 51, respectively, the wiring layers 44, 54 do not come into contact with each other, the adhesion layers 43, 53 do not come into contact with each other, or the substrates 41, 51 do not come into contact with each other, thereby inhibiting the contact of the fixed contact 46 and the movable contact 56 before the fixed contact 46 and the movable contact 56 come into contact with each other. When the fixed contact 46 and the movable contact 56 come into contact with each other, the contact of the wiring layers 44, 54 and the adhesion layers 43, 53 is prevented, and hence the wiring layers 44, 54 and the adhesion layers 43, 53 do not stick to each other thus affecting the lifespan of the contact even if a material of low hardness is used for the wiring layers 44, 54 and the adhesion layers 43, 53.

As the end faces 49, 59 of the wiring layers 44, 54 are inclined to project out towards the upper side, the projecting portions of the conductive layers 45, 55 can be supported by the wiring layers 44, 54 while avoiding the wiring layers 44, 54 from coming into contact with each other.

According to such a structure of the switch 31, various manufacturing methods as will be described below can be adopted.

(Third Manufacturing Method)

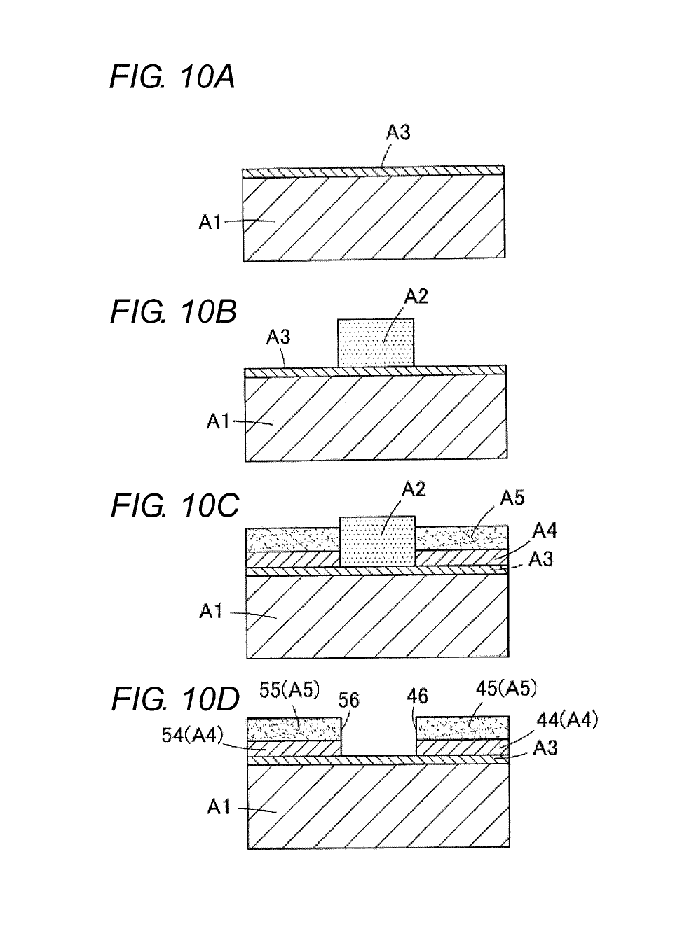

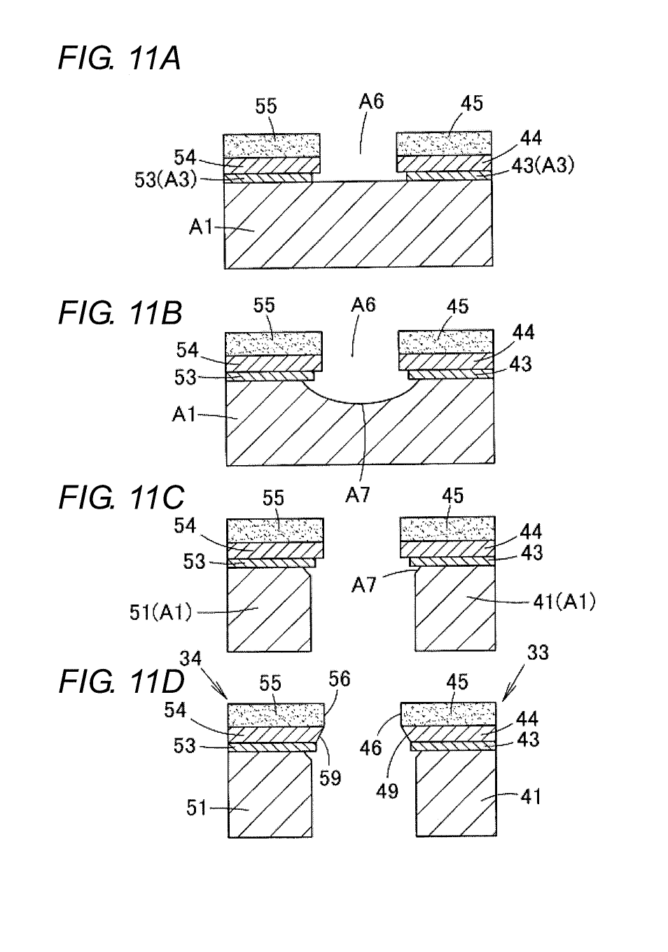

The switch 31 is manufactured using the MEMS technique. FIGS. 10A to 10D and FIGS. 11A to 11D show one example of the manufacturing steps of the switch 31.

FIG. 10A shows a state in which the adhesion layer A3 is formed on the upper surface of the substrate A1 made of Si through methods such as vapor deposition and sputtering. The adhesion layer A3 uses a material of high adhesiveness for the lower layer, which is a material such as Cr and Ti, and forms a material of low resistance, which is a material such as Au, Cu, and Al thereon. After the adhesion layer A3 is formed on the upper surface of the substrate A1, the photoresist is applied on the upper surface of the adhesion layer A3, the photoresist is patterned through the photolithography technique, and the mold portion A2 is arranged in a region other than the region to form the wiring patterns 48, 58 at the upper surface of the adhesion layer A3, as shown in FIG. 10B.

Then, as shown in FIG. 10C, the material of the wiring layer is deposited on the adhesion layer A3 through the method such as vapor deposition, sputtering, and electrolytic plating, and a wiring layer A4 is stacked in a region to form the wiring patterns 48 and 58. The material of the conductive layer is thereafter deposited on the wiring layer A4 through the method such as vapor deposition, sputtering, and electrolytic plating, and a conductive layer A5 is stacked in a region to form the wiring patterns 48 and 58.

Subsequently, the resultant is immersed in a stripping solution to strip the mold portion A2, whereby the wiring layers 44, 54 and the conductive layers 45, 55 are formed in the region to form the wiring patterns 48 and 58, as shown in FIG. 10D. The end faces of the conductive layers 45, 55 in contact with the mold portion A2 are smoothly formed and parallel to each other, and respectively become the fixed contact 46 and the movable contact 56.

The adhesion layer A3 is then selectively etched using the etchant, to which the wiring layers 44, 54, the conductive layers 45, 55 and the substrate A1 have resistance, to remove the region exposed from the conductive layers 45, 55 of the adhesion layer A3 and over-etch the adhesion layer A3 to retreat the edge of the adhesion layer A3 from the edge of the wiring layers 44, 54 and pattern the adhesion layers 43, 53, as shown in FIG. 11A.

Thereafter, the substrate A1 is subjected to isotropic etching with the conductive layers 45, 55 as the mask in the intermediate region A6 of the conductive layer 45 and the conductive layer 55. In this case, as shown in FIG. 11B, the substrate A1 is over-etched so that the upper surface of the substrate A1 is etched to a width wider than the opening width between the adhesion layers 43, 53 using the etching method, to which the conductive layers 45, 55, the wiring layers 44, 54, and the adhesion layers 43, 53 have corrosion resistance, thereby forming a recess A7 at the upper surface of the substrate A1. In the method of performing isotropic etching on the substrate A1, RIE (Reactive Ion Etching) is carried out (e.g., under condition of pressure at 10 to 100 Pa, high frequency power at 50 to and 200 W) with sulfur hexafluoride and perfluorocyclobutane as the gaseous species. The method of performing the isotropic etching also includes a method of performing dry etching using xenon gas for the gaseous species and a method of performing wet etching using fluoro nitric acid.

After the recess A7 is formed at the upper surface of the substrate A1 as shown in FIG. 11B, the substrate A1 is further subjected to anisotropic etching from the recess A7 side with the conductive t layers 45, 55 as the mask, the substrate A1 is divided to the fixed contact substrate 41 and the movable contact substrate 51 through the anisotropic etching so that the end face of the fixed contact substrate 41 is retreated than the fixed contact 46 and the end face of the movable contact substrate 51 is retreated than the movable contact 56 as shown in FIG. 11C. In the method of anisotropic etching, DRIE (Deep Reactive Ion Etching) is carried out (e.g., under condition of pressure at 3 to 10 Pa, high frequency power at 200 to 800 W) with sulfur hexafluoride as the gaseous species. The method of performing the anisotropic etching also includes methods of performing ion milling, and wet etching using KOH aqueous solution and TMAH solution. The distance of the fixed contact substrate 41 and the movable contact substrate 51 after anisotropic etching (or extent of retreating the end faces of the fixed contact substrate 41, movable contact substrate 51) can be controlled by the width of the recess A7 of FIG. 11B.

The end faces of the wiring layers 44, 54 are then etched (etch backed) to incline the end faces 49, 59 of the wiring layers 44, 54. In FIG. 11D, the ends of the upper surfaces of the wiring layers 44, 54 are aligned with the fixed contact 46 and the movable contact 56, but may be retreated from the fixed contact 46 and the movable contact 56. The end faces 49, 59 of the wiring layers 44, 54 may not be inclined surfaces, and may be perpendicular surfaces parallel to the contacts 46, 56 as long as the end faces are retreated from the fixed contact 46 and the movable contact 56.

One of the blocks thereby becomes the fixed contact portion 33 in which the fixed contact substrate 41, the adhesion layer 43, the wiring layer 44, and the conductive layer 45 are stacked. The fixed contact portion 33 is fixed to the upper surface of the base substrate 32 through the insulating film 42. The other block becomes the movable contact portion 34 in which the movable contact substrate 51, the adhesion layer 53, the wiring layer 54, and the conductive layer 55 are stacked. The movable contact portion 34 is ultimately separated from the base substrate 32 by removing the insulating film at the lower surface through etching. The switch 31 (MEMS switch) is formed as a result.

In regards to the switch 31 formed in such a manner, the surfaces that become the fixed contact 46 and the movable contact 56 are the surfaces parallel to the growing direction of the conductive layers 45, 55 and are molded by both side surfaces of the mold portion A2, and hence such surfaces can be smoothly formed compared to the surfaces of the conductive layers 45, 55, and the parallelism can also be enhanced. The contacts 46, 56 thus can be reliably brought into contact with each other, and the contact resistance between the contacts can be reduced. As the contacting surfaces of the contacts 46, 56 become smooth, discharge is less likely to occur when the contacts are brought close, welding of the fixed contact 46 and the movable contact 56 is also less likely to occur, and the open/close lifespan of the switch 31 becomes longer.

Furthermore, according to such a manufacturing method, the inter-contact distance between the fixed contact 46 and the movable contact 56 can be accurately determined by the width of the mold portion A2, and discharge is less likely to occur between the contacts, whereby the inter-contact distance between the fixed contact 46 and the movable contact 56 can be narrowed and the actuator can be driven at low voltage to open and close the contacts.

(Fourth Manufacturing Method)

The switch 31 may also be formed through steps shown in FIGS. 12A to 6D and FIGS. 13A to 13D. The fourth manufacturing method will be described below.

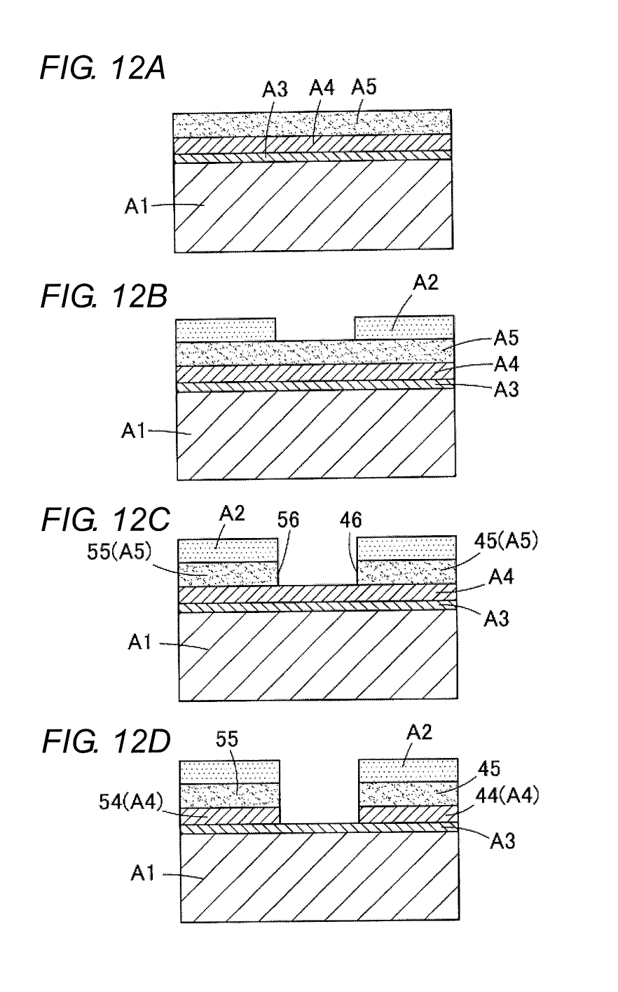

First, as shown in FIG. 12A, the adhesion layer A3 is formed on the upper surface of the substrate A1 made of Si through vapor deposition, sputtering, and the like, and the wiring layer A4 and the conductive layer A5 are stacked on the upper surface thereof.

The photoresist is then applied on the conductive layer A5 and patterned to form the mold portion A2 in the region to form the wiring patterns 48 and 58, as shown in FIG. 12B. After the mold portion A2 is patterned, the exposed region of the conductive layer A5 is selectively etched with the mold portion A2 as the mask to pattern the layers 45, 55 at the upper surface of the wiring layer A4 and form the fixed contact 46 and the movable contact 56 at the end faces of the conductive layers 45, 55, respectively, as shown in FIG. 12C. The etchant is then changed, and the exposed region of the wiring layer A4 is selectively etched with the mold portion A2 as the mask to pattern the wiring layers 44, 54 on the adhesion layer A3, as shown in FIG. 12D.

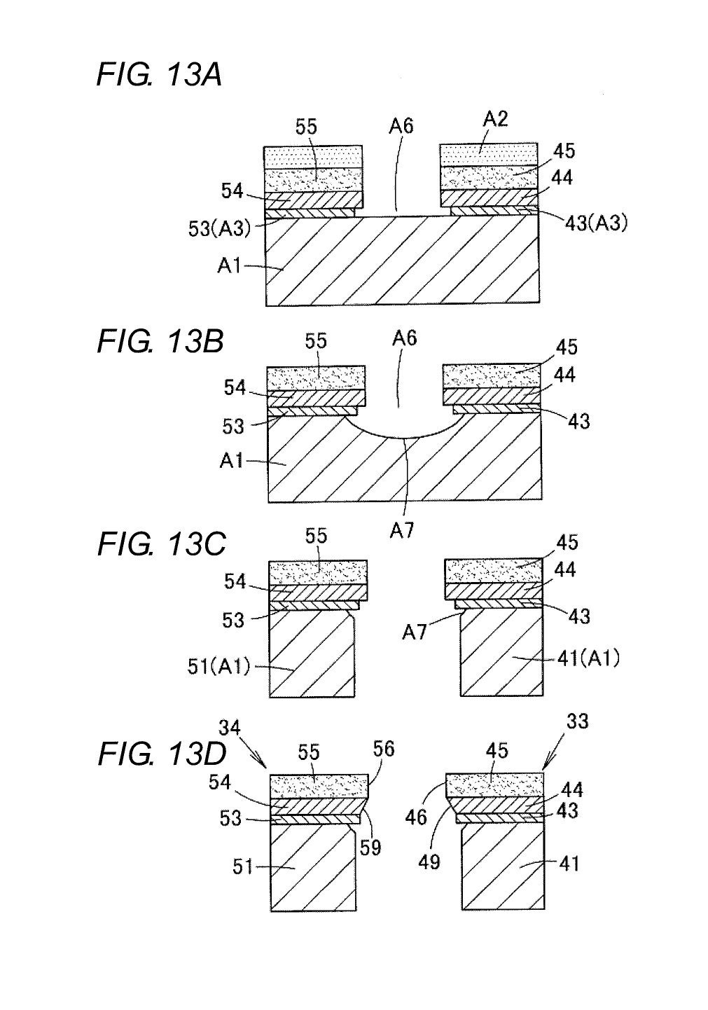

Furthermore, the adhesion layer A3 is selectively etched using the etchant, to which the conductive layers 45, 55 and the substrate A1 have resistance, to remove the region exposed from the conductive layers 45, 55 of the adhesion layer A3 and over-etch the adhesion layer A3 to retreat the edge of the adhesion layer A3 from the edges of the wiring layers 44, 54 and pattern the adhesion layers 43, 53, as shown in FIG. 13A. It is then immersed in the stripping solution to strip the mold portion A2.

Thereafter, the recess A7 is formed at the upper surface of the substrate A1 through isotropic etching (FIG. 13B), the substrate A1 is subjected to anisotropic etching to be divided to the fixed contact substrate 41 and the movable contact substrate 51 (FIG. 13C), and the end faces 49, 59 of the wiring layers 44, 54 are etch backed (FIG. 13D) to form the switch 31 through the steps similar to FIGS. 11B to 11D in the third manufacturing method.

In such a method as well, the fixed contact 46 and the movable contact 56 can be formed by etching the conductive layer A5 with the mold portion A2 as the mask, and hence the fixed contact 46 and the movable contact 56 can be formed so as to be smooth and so as to be parallel to each other. The inter-contact distance of the fixed contact 46 and the movable contact 56 can also be sized at high accuracy.

(Fifth Manufacturing Method)

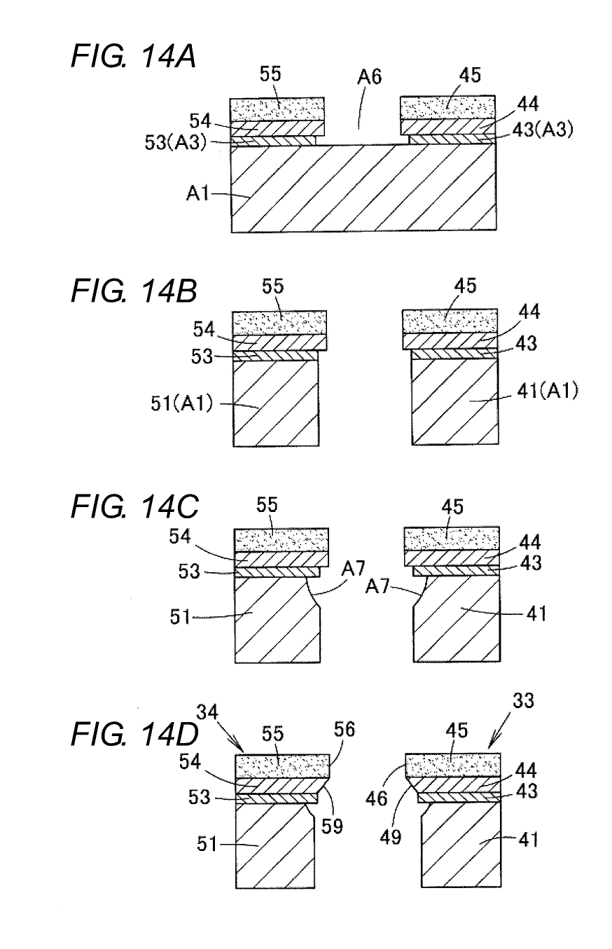

The switch 31 may also be formed through steps shown in FIGS. 10A to 10D and FIGS. 14A to 14D. In the fifth manufacturing method as well, the adhesion layer A3 is first formed on the upper surface of the substrate A1, the mold portion A2 is formed in the region other than the region to form the wiring patterns 48, 58, the wiring layer A4 and the conductive layer A5 are stacked on the adhesion layer A3 in the region to form the wiring patterns 48, 58 and then the mold portion A2 is stripped with the stripping solution through the steps of FIGS. 10A to 10D. The steps of FIGS. 10A to 10D are already described, and thus will be omitted.

In the fifth manufacturing method, after the wiring layers 44, 54 and the conductive layers 45, 55 are formed on the adhesion layer A3 through the steps of FIGS. 10A to 10D, the adhesion layer A3 is selectively etched using the etchant, to which the conductive layers 45, 55 and the substrate A1 have resistance, as shown in FIG. 14A. As a result, the region exposed from the conductive layers 45, 55 of the adhesion layer A3 is removed, and the adhesion layer A3 is over-etched so that the edge of the adhesion layer A3 is retreated than the edges of the wring layers 44, 54.

Thereafter, the substrate A1 is subjected to anisotropic etching from the upper surface side with the conductive layers 45, 55 as the mask in the intermediate region A6 of the conductive layer 45 and the conductive layer 55 to divide the substrate A1 into the fixed contact substrate 41 and the movable contact substrate 51 as shown in FIG. 14B. In the method of anisotropic etching, DRIE is carried out with sulfur hexafluoride as the gaseous species. The method of performing the anisotropic etching also includes methods of performing ion milling, and wet etching using KOH aqueous solution and TMAH solution.

The fixed contact substrate 41 and the movable contact substrate 51 are then subjected to isotropic etching from the upper side with the conductive layers 45, 55 as the mask, and the recess A7 is formed at the corners on the upper surfaces of the fixed contact substrate 41 and the movable contact substrate 51, as shown in FIG. 14C. In this case, the substrate A1 is over-etched so that the upper surface of the substrate A1 is etched to a width wider than the opening width between the adhesion layers 43, 53 using the etching method, to which the conductive layers 45, 55, the wiring layers 44, 54, and the adhesion layers 43, 53 have corrosion resistance. In the method of isotropic etching the fixed contact substrate 41 and the movable contact substrate 51, RIE is carried out with sulfur hexafluoride and perfluorocyclobutane as the gaseous species. The method of performing the isotropic etching also includes a method of performing dry etching using xenon gas for the gaseous species and a method of performing wet etching using fluoro nitric acid.

Moreover, the end faces of the wiring layers 44, 54 are etched (etch backed) to incline the end faces 49, 59 of the wiring layers 44, 54, as shown in FIG. 14D. In FIG. 14D, the ends at the upper surfaces of the wiring layers 44, 54 are aligned with the fixed contact 46 and the movable contact 56, but may be retreated from the fixed contact 46 and the movable contact 56. When etching back the end faces 49, 59 of the wiring layers 44, 54, the fixed contact substrate 41 and the movable contact substrate 51 are further etched at the same time to desirably retreat the end face of the fixed contact substrate 41 from the end face of the adhesion layer 43 and retreat the end face of the movable contact substrate 51 from the end face of the adhesion layer 53.

### Fourth Embodiment

(Structure)

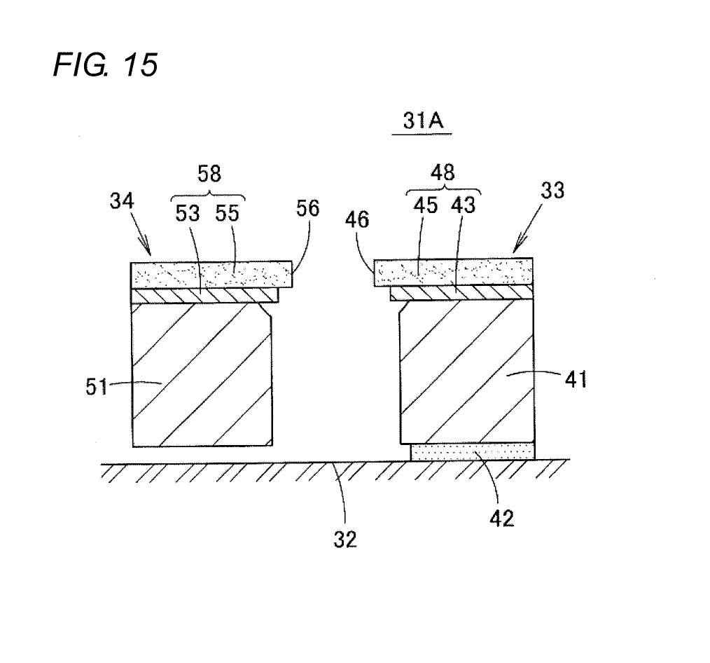

FIG. 15 is a cross-sectional view showing a structure of the switch 31A according to a fourth embodiment of the present invention. In the switch 31A, the conductive layer 45 is directly formed on the adhesion layer 43 formed on the upper surface of the fixed contact substrate 41 to form the fixed contact portion 33, and the conductive layer 55 is directly formed on the adhesion layer 53 formed on the upper surface of the movable contact substrate 51 to form the movable contact portion 34. The fourth embodiment is the same as the third embodiment in that the end faces of the conductive layers 45, 55 that face each other become the fixed contact 46 and the movable contact 56. Therefore, compared to the switch 31 of the third embodiment, the switch 31A does not include the wiring layers 44, 54, the wiring pattern 48 has a two-layer structure of the adhesion layer 43 and the conductive layer 45, the wiring pattern 48 has a two-layer structure of the adhesion layer 53 and the conductive layer 55, and the conductive layers 45, 55 have both a function of bringing the contacts in contact with each other and a function (function of wiring layer) of transmitting signals.

(Sixth Manufacturing Method)

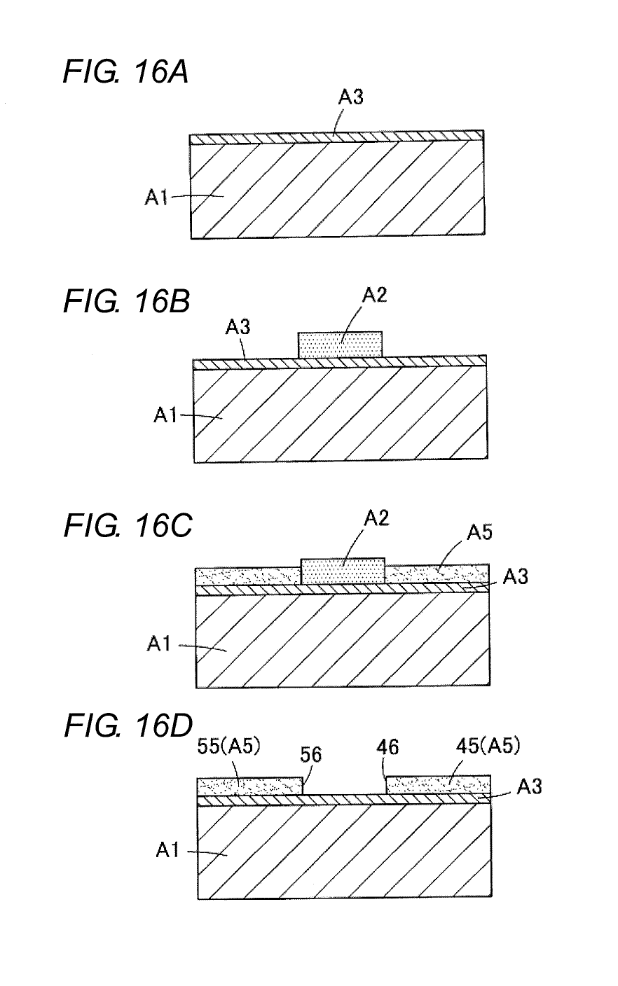

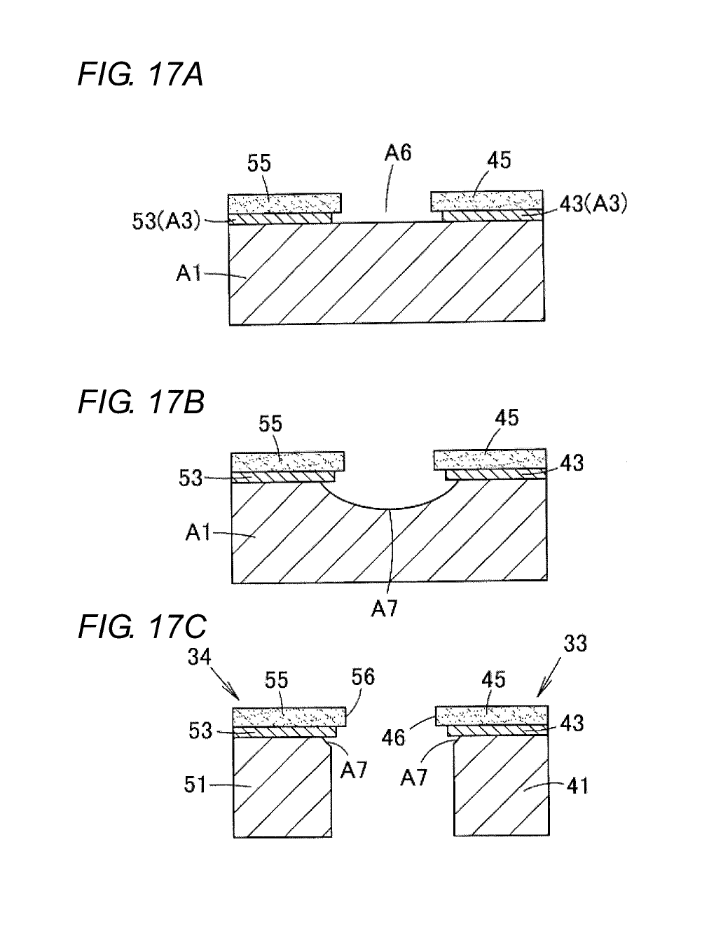

FIGS. 16A to 16D and FIGS. 17A to 17C show one example of the manufacturing steps of the switch 31A.

FIG. 16A shows a state in which the adhesion layer A3 is formed on the upper surface of the substrate A1 made of Si through methods such as vapor deposition and sputtering. The adhesion layer A3 uses a material of high adhesiveness for the lower layer, which is a material such as Cr and Ti, and forms a material of low resistance, which is a material such as Au, Cu, and Al thereon. After the adhesion layer A3 is formed on the upper surface of the substrate A1, the photoresist is applied on the upper surface of the adhesion layer A3, the photoresist is patterned through the photolithography technique, and the mold portion A2 is arranged in a region other than the region to form the wiring patterns 48, 58 at the upper surface of the adhesion layer A3, as shown in FIG. 10B.

Then, as shown in FIG. 16C, the material of the conductive layer is deposited on the adhesion layer A3 through the method such as vapor deposition, sputtering, and electrolytic plating, and the conductive layer A5 is stacked in a region to form the wiring patterns 48 and 58.

Thereafter, the mold portion A2 is removed, and the conductive layers 45, 55 are formed in the region to form the wiring patterns 48, 58, as shown in FIG. 16D. As a result, the end faces of the conductive layers 45, 55 in contact with the mold portion A2 are smoothly formed parallel to each other, and become the fixed contact 46 and the movable contact 56, respectively.

The adhesion layer A3 is then selectively etched using the etchant, to which the conductive layers 45, 55 and the substrate A1 have resistance, to remove the region exposed from the conductive layers 45, 55 of the adhesion layer A3 and over-etch the adhesion layer A3 to retreat the edge of the adhesion layer A3 from the edges of the conductive layers 45, 55 and pattern the adhesion layers 43, 53, as shown in FIG. 17A.

Thereafter, the substrate A1 is subjected to isotropic etching with the conductive layers 45, 55 as the mask in the intermediate region A6 of the conductive layer 45 and the conductive layer 55. In this case, as shown in FIG. 17B, the substrate A1 is over-etched so that the upper surface of the substrate A1 is etched to a width wider than the opening width between the adhesion layers 43, 53 using the etching method, to which the conductive layers 45, 55 and the adhesion layers 43, 53 have resistance, thereby forming the recess A7 at the upper surface of the substrate A1. In the method of isotropic etching the substrate A1, RIE is carried out (e.g., under condition of pressure at 10 to 100 Pa, high frequency power at 50 to 200 W) with sulfur hexafluoride and perfluorocyclobutane as the gaseous species. The method of performing the isotropic etching also includes a method of performing dry etching using xenon gas for the gaseous species and a method of performing wet etching using fluoro nitric acid.

After the recess A7 is formed at the upper surface of the substrate A1 as shown in FIG. 17B, the substrate A1 is further subjected to anisotropic etching from the recess A7 side with the conductive layers 45, 55 as the mask, the substrate A1 is divided to the fixed contact substrate 41 and the movable contact substrate 51 through the anisotropic etching and etched until the end face of the fixed contact substrate 41 and the end face of the movable contact substrate 51 are retreated than the ends of the adhesion layers, 43, 53, respectively as shown in FIG. 17C. In the method of anisotropic etching, DRIE is carried out (e.g., under condition of pressure at 3 to 10 Pa, high frequency power at 200 to 800 W) with sulfur hexafluoride as the gaseous species. The method of performing the anisotropic etching also includes methods of performing ion milling, and wet etching using KOH aqueous solution and TMAH solution. The distance of the fixed contact substrate 41 and the movable contact substrate 51 after anisotropic etching (or extent of retreating the end faces of the fixed contact substrate 41, movable contact substrate 51) can be controlled by the width of the recess A7 of FIG. 17B.

One of the blocks thereby becomes the fixed contact portion 33 in which the fixed contact substrate 41, the adhesion layer 43, and the conductive layer 45 are stacked. The fixed contact portion 33 is fixed to the upper surface of the base substrate 32 through the insulating film 42. The other block becomes the movable contact portion 34 in which the movable contact substrate 51, the adhesion layer 53, and the conductive layer 55 are stacked. The movable contact portion 34 is ultimately separated from the base substrate 32 by removing the insulating film at the lower surface through etching. The switch 31A (MEMS switch) is thereby formed.

In regards to the switch 31A formed in such a manner, the surfaces that become the fixed contact 46 and the movable contact 56 is molded by both side surfaces of the mold portion A2, and hence can be smoothly formed compared to the surfaces of the conductive layers 45, 55 and the parallelism is also enhanced. The contacts 46, 56 thus can be reliably brought into contact with each other, and the contact resistance between the contacts can be reduced. As the contacting surfaces of the contacts 46, 56 become smooth, discharge is less likely to occur when the contacts are brought close, welding of the fixed contact 46 and the movable contact 56 is also less likely to occur, and the open/close lifespan of the switch 31A becomes longer.

Furthermore, according to such a manufacturing method, the distance between the fixed contact 46 and the movable contact 56 can be accurately determined without variation by the width of the mold portion A2, and discharge is less likely to occur between the contacts, whereby the distance between the fixed contact 46 and the movable contact 56 can be narrowed and the actuator can be driven at low voltage to open and close the contacts.

(Seventh Manufacturing Method)

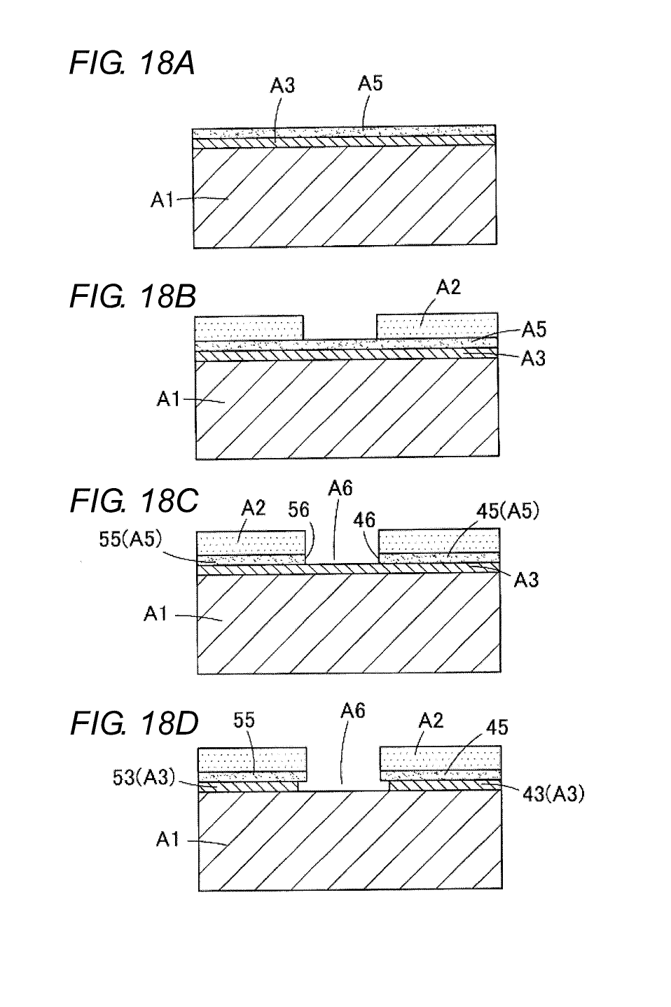

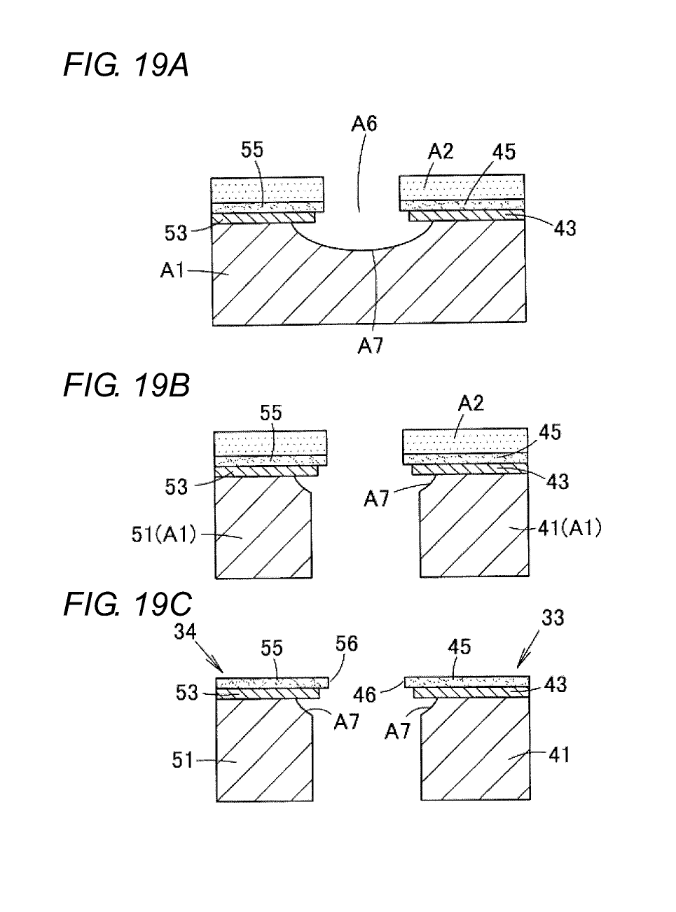

The switch 31A may be formed through steps shown in FIGS. 18A to 18D and FIGS. 19A to 19C. The fourth manufacturing method will be described below.

First, as shown in FIG. 18A, the adhesion layer A3 is formed on the upper surface of the substrate A1 made of Si through vapor deposition, sputtering, and the like, and the conductive layer A5 is formed on the upper surface thereof.

The photoresist is then applied on the conductive layer A5 and patterned to form the mold portion A2 in the region to form the wiring patterns 48 and 58, as shown in FIG. 18B. After the mold portion A2 is patterned, the exposed region of the conductive layer A5 is selectively etched with the mold portion A2 as the mask to pattern the contact layers 45, 55 and form the fixed contact 46 and the movable contact 56 at the end faces of the conductive layers 45, 55, respectively, as shown in FIG. 18C.

Furthermore, the adhesion layer A3 is selectively etched using the etchant, to which the conductive layers 45, 55 and the substrate A1 have resistance, to remove the region exposed from the conductive layers 45, 55 of the adhesion layer A3 and over-etch the adhesion layer A3 to retreat the edge of the adhesion layer A3 from the edges of the conductive layers 45, 55 and pattern the adhesion layers 43, 53, as shown in FIG. 18D.

Thereafter, the substrate A1 is subjected to isotropic etching with the mold portion A2 as the mask in the intermediate region A6 of the conductive layer 45 and the conductive layer 55. In this case, as shown in FIG. 19A, the substrate A1 is over-etched so that the upper surface of the substrate A1 is etched to a width wider than the opening width between the adhesion layers 43, 53 using the etching method, to which the conductive layers 45, 55 and the adhesion layers 43, 53 have resistance, thereby forming the recess A7 at the upper surface of the substrate A1.

After the recess A7 is formed at the upper surface of the substrate A1 as shown in FIG. 19B, the substrate A1 is further subjected to anisotropic etching from the recess A7 side with the mold portion A2 as the mask, the substrate A1 is divided to the fixed contact substrate 41 and the movable contact substrate 51 through the anisotropic etching so that the end face of the fixed contact substrate 41 and the end face of the movable contact substrate 51 are respectively retreated than the ends of the adhesion layers 43, 53 as shown in FIG. 19B.

The mold portion A2 on the wiring layers 44, 54 is then stripped by the stripping solution, thereby forming the switch 31A.

In the switch 31A formed in such a manner, the surfaces that becomes the fixed contact 46 and the movable contact 56 are molded through etching, and thus can be smoothly formed compared to the surfaces of the conductive layers 45, 55, and the parallelism is also enhanced. The contacts 46, 56 thus can be reliably brought into contact with each other, and the contact resistance between the contacts can be reduced. As the contacting surfaces of the contacts 46, 56 become smooth, discharge is less likely to occur when the contacts are brought close, welding of the fixed contact 46 and the movable contact 56 is also less likely to occur, and the open/close lifespan of the switch 31A becomes longer. The distance between the fixed contact 46 and the movable contact 56 thus can be narrowed, and the actuator can be driven at low voltage to open and close the contacts.

The fixed contact 46 and the movable contact 56 both project out from the end faces of each substrate 41, 51, the adhesion layers 43, 53, and the wiring layers 44, 54 in the switch 31, and the fixed contact 46 and the movable contact 56 both project out from the end faces of each substrate 41, 51, and the adhesion layers 43, 53 in the switch 31A, but only one of the contacts of the fixed contact 46 or the movable contact 56 may project out, and the other contact may be aligned with the ends of the substrate, the adhesion layers, and the like.

### Fifth Embodiment

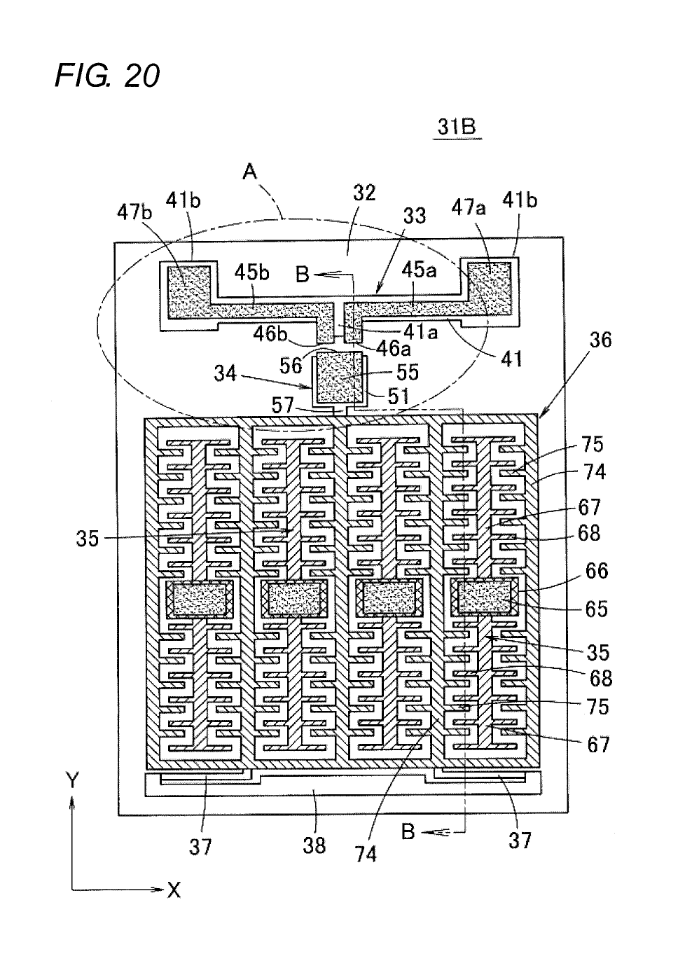

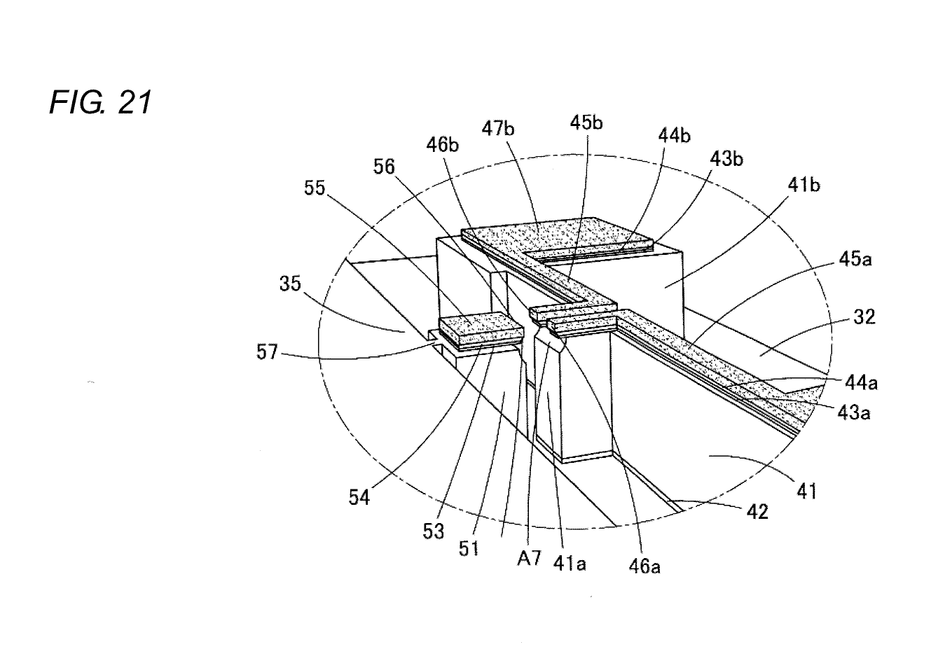

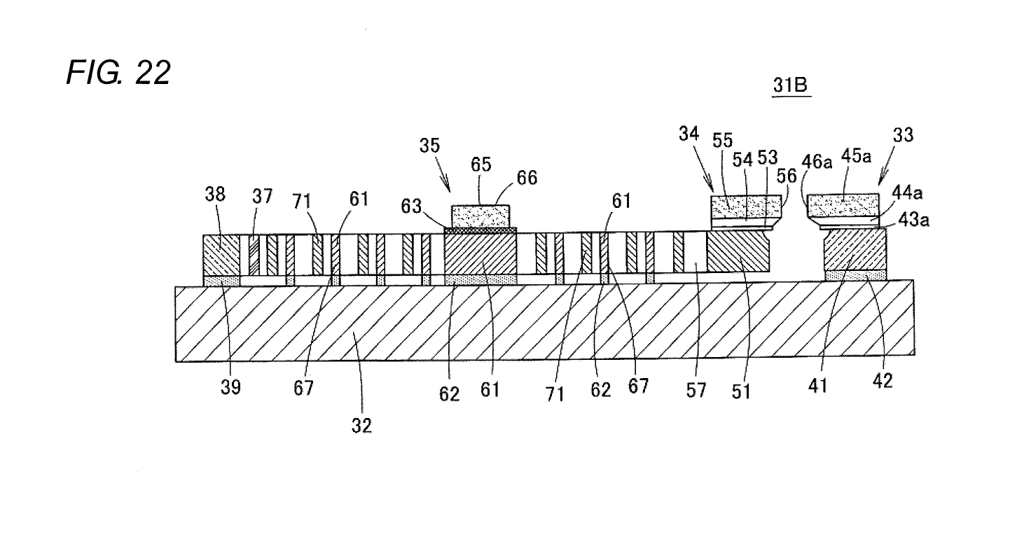

A structure of an electrostatic relay 31A for high frequency according to a fifth embodiment of the present invention will now be described. FIG. 20 is a plan view showing a structure of the electrostatic relay 31B. FIG. 21 is a perspective view showing an area A of FIG. 20 in an enlarged manner, and FIG. 22 is a schematic cross-sectional view taken along line B-B of FIG. 20.

The electrostatic relay 31B has the fixed contact portion 33, the movable contact portion 34, a fixed electrode portion 35, a movable electrode portion 36 for supporting the movable contact portion 34, an elastic spring 37, and a supporting portion 38 for supporting the elastic spring 37 arranged on the upper surface of the base substrate 32 including the Si substrate, the glass substrate, or the like.

As shown in FIG. 22, the fixed contact portion 33 has the lower surface of the fixed contact substrate 41 made of Si fixed to the upper surface of the base substrate 32 by the insulating film 42 (SiO2). As shown in FIG. 21, the adhesion layers 43a, 43b having a two-layer structure in which the material of high adhesiveness (e.g., material of Cr, Ti, etc.) is used for the lower layer and the low resistance material (e.g., material of Au, Cu, Al, etc.) is formed thereon are formed on the upper surface of the fixed contact substrate 41, and the wiring layers 44a, 44b of Pt and the like and the conductive layers 45a, 45b are stacked on the adhesion layers 43a, 43b.

As shown in FIG. 20 and FIG. 21, the fixed contact substrate 41 extends in the width direction (X direction) at the end on the upper surface of the base substrate 32, where a bulging-out portion 41a projecting out towards the movable contact portion 34 side is formed at the central part and pad supporting portions 41b, 41b are formed at both ends. The wiring patterns 48a, 48b are wired along the upper surface of the fixed contact substrate 41, where one of the ends of the wiring patterns 48a, 48b are arranged parallel to each other on the upper surface of the bulging-out portion 41a, and the distal end faces of the conductive layers 45a, 45b projecting out from the end face of the bulging-out portion 41a are positioned within the same plane to become the fixed contacts 46a, 46b (electrical contacting surface), respectively. The other ends of the wiring patterns 48a, 48b have metal pad portions 47a, 47b formed on the upper surface of the pad supporting portions 41b, 41b. If the wiring pattern 48 has a three-layer structure of the adhesion layer 43a, 43b, the wiring layer 44a, 44b, and the conductive layer 45a, 45b as in the switch 31 of FIG. 3, the conductive layers 45a, 45b may not necessarily be arranged over the entire wiring patterns 48a, 48b, and merely need to be arranged at least near the bulging-out portion 41a including the fixed contact 46 and the movable contact 56.

The movable contact portion 34 is arranged at a position facing the bulging-out portion 41a. As shown in FIG. 21, the movable contact portion 34 has the adhesion layer 53 including the lower layer Cr/upper layer Au formed on the upper surface of the movable contact substrate 51 made of Si, where the wiring layer 54 of Pt and the like and the conductive layer 55 are stacked on the adhesion layer 53. As shown in FIG. 22, the end face of the conductive layer 55 facing the conductive layers 45a, 45b projects out from the front surface of the movable contact substrate 51, and is also formed parallel to the fixed contacts 46a, 46b, whereby the relevant end face becomes the movable contact 56 (electrical contacting surface). The movable contact 56 has a width substantially equal to the distance from the edge on the outer side of the fixed contact 46a to the edge on the outer side of the fixed contact 46b.

The movable contact substrate 51 is supported in a cantilever manner by a supporting beam 57 projecting out from the movable electrode portion 36. The lower surfaces of the movable contact substrate 51 and the supporting beam 57 are floating from the upper surface of the base substrate 32, and can move parallel to the length direction (Y direction) of the base substrate 32 with the movable electrode portion 36.

In the electrostatic relay 31B, a main circuit (not shown) is connected to the metal pad portions 47a, 47b of the fixed contact portion 33, where the main circuit can be closed by bringing the movable contact 56 into contact with the fixed contacts 46a, 46b, and the main circuit can be opened by separating the movable contact 56 from the fixed contacts 46a, 46b. The end faces of the wiring layers 44a, 44b, 54 are inclined to retreat towards the lower side, and the end faces of the bulging-out portion 41a and the movable contact substrate 51 are also retreated from the fixed contacts 46a, 46b and the movable contact 56, and hence the wiring layers 44a, 44b do not come into contact with the wiring layer 54, or the bulging-out portion 41a do not come into contact with the movable contact substrate 51 when closing the contacts thereby preventing the movable contact 56 and the fixed contacts 46a, 46b from causing contact failure.

The actuator for moving the movable contact portion 34 is configured by the fixed electrode portion 35, the movable electrode portion 36, the elastic spring 37, and the supporting portion 38.

As shown in FIG. 20, a plurality of fixed electrode portions 35 are arranged in parallel to each other on the upper surface of the base substrate 32. In plan view, the fixed electrode portion 35 has a branch-like electrode part 67 of a branch-shape extending in the Y direction from both surfaces of a rectangular pad portion 66. The branch-like electrode part 67 has a branch portion 68 projecting out so as to be symmetrical to each other, which branch portion 68 is lined at a constant pitch in the Y-direction.

As shown in FIG. 22, the lower surface of the fixed electrode substrate 61 is fixed to the upper surface of the base substrate 32 by the insulating film 62 in the fixed electrode portion 35. Furthermore, in the pad portion 66, the fixed electrode 63 is formed by Cu, Al, and the like on the upper surface of the fixed electrode substrate 61, and the electrode pad layer 65 is arranged on the fixed electrode 63.

As shown in FIG. 20, the movable electrode portion 36 is formed to surround each fixed electrode portion 35. The movable electrode portion 36 includes a comb teeth like electrode portion 74 formed so as to sandwich each fixed electrode portion 35 from both sides (branch-shape by a pair of comb teeth like electrode portions 74 between the fixed electrode portions 35). The comb teeth like electrode portion 74 is symmetric with each fixed electrode portion 35 as the center, where a comb teeth part 75 extends from each comb teeth like electrode portion 74 to a clearance between the branch portions 68. Furthermore, each comb teeth part 75 has the distance with the branch portion 68 positioned on the side close to the movable contact portion 34 adjacent to the comb teeth part 75 shorter than the distance with the branch portion 68 positioned on the side distant from the movable contact portion 34 adjacent to the comb teeth part 75.

The movable electrode portion 36 includes a movable electrode substrate 71 of Si, where the lower surface of the movable electrode substrate 71 is floating from the upper surface of the base substrate 32. The supporting beam 57 is arranged in a projecting manner at the center of the end face on the movable contact side of the movable electrode portion 36, and the movable contact portion 34 is held at the distal end of the supporting beam 57.

The supporting portion 38 is made of Si, and extends long in the X direction at the other end of the base substrate 32. The lower surface of the supporting portion 38 is fixed to the upper surface of the base substrate 32 by the insulating film 39. Both ends of the supporting portion 38 and the movable electrode portion 36 (movable electrode substrate 71) are connected by a pair of elastic springs 37 formed symmetrically by Si, where the movable electrode portion 36 is horizontally supported by the supporting portion 38 by way of the elastic spring 37. The movable electrode portion 36 is movable in the Y direction by elastically deforming the elastic spring 37.

In the electrostatic relay 31B having the above structure, a DC voltage source is connected between the fixed electrode portion 35 and the movable electrode portion 36, and the DC voltage is turned ON and OFF by the control circuit and the like. In the fixed electrode portion 35, one terminal of the DC voltage source is connected to the electrode pad layer 65. The other terminal of the DC voltage source is connected to the supporting portion 38. The supporting portion 38 and the elastic spring 37 have conductivity, and the supporting portion 38, the elastic spring 37, and the movable electrode portion 36 are electrically conducted, and hence the voltage applied to the supporting portion 38 will be applied to the movable electrode portion 36.

When the DC voltage is applied between the fixed electrode portion 35 and the movable electrode portion 36 by the DC voltage source, an electrostatic attractive force is generated between the branch portion 68 of the branch like electrode part 67 and the comb teeth part 75 of the comb teeth like electrode portion 74. However, the electrostatic attractive force in the X direction acting on the movable electrode portion 36 becomes balanced because the structure of the fixed electrode portion 35 and the movable electrode portion 36 is formed symmetric with respect to the center line of each fixed electrode portion 35, whereby the movable electrode portion 36 does not move in the X direction. Because the distance with the branch portion 68 positioned on the side close to the movable contact portion 34 adjacent to the comb teeth part 75 is shorter than the distance with the branch portion 68 positioned on the side distant from the movable contact portion 34 adjacent to the comb teeth part 75, each comb teeth part 75 is attracted to the movable contact portion side, and the movable electrode portion 36 moves in the Y direction while bending the elastic spring 37. As a result, the movable contact portion 34 moves to the fixed contact portion 33 side, and the movable contact 56 comes into contact with the fixed contacts 46a, 46b thereby electrically closing the fixed contact 46a and the fixed contact 46b (main circuit).

When the DC voltage applied between the fixed electrode portion 35 and the movable electrode portion 36 is released, the electrostatic attractive force between the branch portion 68 and the comb teeth part 75 disappears, whereby the movable electrode portion 36 moves backward in the Y direction by the elastic returning force of the elastic spring 37 thereby separating the movable contact 56 from the fixed contacts 46a, 46b and opening the fixed contact 46a and the fixed contact 46b (main circuit).

Such an electrostatic relay 31B is formed through the following steps. First, the Si substrate (another Si wafer having conductivity) is joined to the upper surface of the base substrate (Si wafer, SOI wafer, etc.) having the entire surface covered with the insulating film, and the metal material is vapor deposited on the upper surface of the Si substrate to form the electrode film. The electrode film is then patterned by the photolithography technique, and the fixed electrode 63 is formed on the upper surface of the fixed electrode substrate 61 at the pad portion 66 by the electrode film.

Then, the adhesion layer is formed on the upper surface of the Si substrate from above the electrode film, and then the wiring layer and the conductive layer are stacked thereon. The conductive layer, the wiring layer, and the adhesion layer are then patterned to form the wiring pattern 48 of the fixed contact portion 33 and the wiring pattern 58 of the movable contact portion 34. The electrode pad layer 65 is formed on the fixed electrode 63 at the pad portion 66.

Thereafter, the Si substrate is etched with the photoresist, and the like as the etching mask, and the fixed contact substrate 41 of the fixed contact portion 33, the movable contact substrate 51 of the movable contact portion 34, the fixed electrode substrate 61 of the fixed electrode portion 35, the movable electrode substrate 71 of the movable electrode portion 36, the elastic spring 37, and the supporting portion 38 are formed from the Si substrate remaining in each region.

Lastly, the insulating film of the region exposed from the Si substrate and the insulating film at the lower surfaces of the movable contact portion 34 and the movable electrode portion 36 are removed through etching, and then cut to individual electrostatic relay 31B.

The movable contact portion 34 and the fixed electrode portion 35 are formed through steps similar to the steps described in relation to the switch 31 of the first embodiment in the manufacturing steps of the electrostatic relay 31B, and hence the fixed contacts 46a, 46b of the fixed contact portion 33 and the movable contact 56 of the movable contact portion 34 become side surfaces parallel to the growing direction of the conductive layer, and a contact having satisfactory smoothness and parallelism can be obtained without performing polishing and the like. Effects similar to the switch 31 of the third embodiment thus can be obtained in the electrostatic relay 31B as well.

While the invention has been described with respect to a limited number of embodiments, those skilled in the art, having the benefit of this disclosure, will appreciate that other embodiments can be devised which do not depart from the scope of the invention as disclosed herein. Accordingly, the scope of the invention should be limited only by the attached claims.

1. A switch comprising:
a plurality of contacts that come into contact with or separate from each other;
a first contact portion in which a plurality of layers including a first conductive layer is formed on an upper side of a first substrate; and
a second contact portion in which a plurality of layers including a second conductive layer is formed on an upper side of a second substrate,
wherein a surface parallel to a growing direction, when forming a conductive layer for forming the contacts, is a contacting surface of the contacts,
wherein an end face parallel to the growing direction, when forming the conductive layer in the first conductive layer, is a contact of the first contact portion,
wherein an end face parallel to the growing direction, when forming the conductive layer in the second conductive layer, is a contact of the second contact portion,
wherein the contact of the contact portion projects out than an end face of a layer other than the conductive layer in the contact portion and the substrate of the contact portion in at least one of the contact portions of the first contact portion and the second contact portion, and
wherein the contact of the first contact portion and the contact of the second contact portion face each other so that the contacts come into contact with or separate from each other.

2. The switch according to claim 1, wherein, when growing the conductive layer, the contacting surface of the contact is a surface in contact with a mold portion for defining a forming region of the conductive layer.

3-7. (canceled)

8. A relay comprising the switch according to claim 1:
an actuator for moving one part of the contact in a direction perpendicular to the contacting surfaces of the contacts to cause the contacts to come into contact with and separate from each other.

9. (canceled)

10. The switch according to claim 1, wherein the first and second conductive layers are formed from any of a noble metal, an alloy, an Si material having conductivity, and a conductive oxide.

11. The switch according to claim 1,
wherein the first contact portion has a first wiring layer formed on the upper side of the first substrate and the first conductive layer formed on the upper surface of the first wiring layer, and
wherein the second contact portion has a second wiring layer formed on the upper side of the second substrate and the second conductive layer formed on the upper surface of the second wiring layer.

12. The switch according to claim 11, wherein an end face of the wiring layer of the contact portion is an inclined surface gradually retreating in a direction of approaching the substrate of the contact portion from an end on the side in contact with the conductive layer of the contact portion in at least one of the contact portions in which the contact projects out than the end faces of the layer other than the conductive layer and the substrate.

13. The switch according to claim 11, wherein the first and second wiring layers are formed from any of a noble metal, an alloy, an Si material having conductivity, and a conductive oxide.

14-19. (canceled)

20. A relay comprising the switch according to claim 1 further comprising:
an actuator for moving at least one of the first contact portion and the second contact portion in a direction perpendicular to contacting surfaces of a contact of the first contact portion and a contact of the second contact portion to cause the contacts to come into contact with and separate from each other.
